(19) United States
(12) Patent Application Publication
(10) Pub. No.: US 2016/0202948 A1
(43) Pub. Date: Jul. 14, 2016

(54) CAUSATION OF STYLISTIC MIMICRY ON A COMPANION APPARATUS

(71) Applicant: NOKIA TECHNOLOGIES OY, Espoo (FI)

(72) Inventors: Zhigang CHEN, Beijing (CN); Guangjun WANG, Beijing (CN)

(73) Assignee: Nokia Technologies Oy, Espoo (FI)

(21) Appl. No.: 14/912,847

(22) PCT Filed: Aug. 21, 2013
(86) PCT No.: PCT/CN2013/081930

§ 371 Date: Feb. 18, 2016

(51) Int. Cl. G06F 3/14; G06F 3/0484; G06F 3/0481; G06T 13/80; H04L 29/06; G09G 5/12

(52) U.S. Cl. CPC G06F 3/1454; H04L 65/1069; G09G 5/12; G06F 3/04817; G06T 13/80; G06F 3/0481; G06F 3/0484

(57) ABSTRACT

An apparatus for performing causing establishment of a communication channel between the an apparatus and a separate apparatus, identifying the separate apparatus as a companion apparatus, causing sending of an interface style mimicry directive to the separate apparatus based, at least in part, on the identification of the companion apparatus, the interface style mimicry directive being a directive that instructs the separate apparatus to perform user interaction in compliance with the interface style mimicry directive absent control from the apparatus, and causing termination of the communication channel is disclosed.

### TECHNICAL FIELD

The present application relates generally to causation of stylistic mimicry on a companion apparatus.

### BACKGROUND

Many users have become dependent on electronic apparatuses to manage various aspects of their lives. For example, many users keep track of many of their appointments, meetings and other events in a calendar program on their electronic apparatus. In addition, many users utilize electronic apparatuses for communication. Furthermore, many users have multiple electronic apparatuses. It may be desirable to allow users to interoperate multiple electronic apparatuses in a simple and intuitive manner.

### SUMMARY

Various aspects of examples of the invention are set out in the claims.

One or more embodiments may provide an apparatus, a computer readable medium, a non-transitory computer readable medium, a computer program product, and a method for causing establishment of a communication channel between an apparatus and a separate apparatus, identifying the separate apparatus as a companion apparatus, causing sending of an interface style mimicry directive to the separate apparatus based, at least in part, on the identification of the companion apparatus, the interface style mimicry directive being a directive that instructs the separate apparatus to perform user interaction in compliance with the interface style mimicry directive absent control from the apparatus, and causing termination of the communication channel.

One or more embodiments may provide an apparatus, a computer readable medium, a computer program product, and a non-transitory computer readable medium having means for causing establishment of a communication channel between the an apparatus and a separate apparatus, means for identifying the separate apparatus as a companion apparatus, means for causing sending of an interface style mimicry directive to the separate apparatus based, at least in part, on the identification of the companion apparatus, the interface style mimicry directive being a directive that instructs the separate apparatus to perform user interaction in compliance with the interface style mimicry directive absent control from the apparatus, and means for causing termination of the communication channel.

In at least one example embodiment, the interface style mimicry directive comprises information associated with modification of a native interface style of the separate apparatus to be similar to a native interface style of the apparatus.

In at least one example embodiment, the sending of the interface style mimicry directive is predicated by the identification of the companion apparatus.

In at least one example embodiment, the apparatus is configured to execute an operating environment of the apparatus and the interface style mimicry directive relates to a native interface style of the operating environment of the apparatus.

In at least one example embodiment, the operating environment of the apparatus relates to an operating system of the apparatus and the native interface style relates to a native interface style of the operating system.

In at least one example embodiment, the native interface style relates to at least one stylistic aspect of the interface style of the operating environment.

In at least one example embodiment, the stylistic aspect relates to an aspect of the native interface style of the operating environment that is non-configurable by way of a setting of the operating environment.

In at least one example embodiment, the stylistic aspect relates to at least one interactive stylistic aspect.

In at least one example embodiment, the interactive stylistic aspect relates to a presentation stylistic aspect.

In at least one example embodiment, the interactive stylistic aspect relates to a program icon stylistic aspect.

In at least one example embodiment, the program icon stylistic aspect relates to at least one of icon shape, icon color palate, or icon border.

In at least one example embodiment, the program icon stylistic aspect relates to a program icon size variability aspect.

In at least one example embodiment, the program icon size variability aspect relates to an aspect that governs availability of a non-stylistic setting that governs size of a particular program icon.

In at least one example embodiment, the program icon stylistic aspect relates to a program icon notification presentation aspect.

In at least one example embodiment, the icon notification presentation aspect relates to preclusion of a program icon from representing information indicative of a notification associated with a program represented by the program icon.

In at least one example embodiment, the icon notification presentation aspect relates to inclusion of a notification count by a program icon, the notification count being indicative of a number of notifications associated with a program represented by the program icon.

In at least one example embodiment, the icon notification aspect relates to inclusion of a notification count by a program icon absent a representation of content of a notification associated with a program represented by the program icon.

In at least one example embodiment, the icon notification aspect relates to inclusion of a representation of content of a notification associated with a program represented by the program icon.

In at least one example embodiment, the presentation stylistic aspect relates to an animation stylistic aspect.

In at least one example embodiment, the animation stylistic aspect governs one or more animations associated with one or more events in the operating environment.

In at least one example embodiment, the animation stylistic aspect governs a scroll animation.

In at least one example embodiment, the animation stylistic aspect governs presence of a bounce animation to signify a scroll endpoint.

In at least one example embodiment, the animation stylistic aspect governs a program open animation.

In at least one example embodiment, the animation stylistic aspect governs a program close animation.

In at least one example embodiment, the presentation stylistic aspect relates to a selection item aspect.

In at least one example embodiment, the selection item aspect governs a manner in which a selectable interface item is represented to a user.

In at least one example embodiment, the selection item aspect governs a radio button representation aspect.

In at least one example embodiment, the radio button representation aspect relates to an interface element that provides for selection of one of a set of enumerated options.

In at least one example embodiment, the radio button representation aspect relates to a selectable button representation.

In at least one example embodiment, the radio button representation aspect relates to a selectable enclosure representation.

In at least one example embodiment, the selectable enclosure representation relates to at least one of a selectable box or a selectable circle.

In at least one example embodiment, the selection item aspect governs a binary selection aspect.

In at least one example embodiment, the binary selection aspect relates to an interface element that provides for selection of one of two enumerated options.

In at least one example embodiment, the binary selection aspect relates to a slider interface element.

In at least one example embodiment, the binary selection aspect relates to a selectable toggle button representation.

In at least one example embodiment, the selection item aspect relates to a numeric selection aspect.

In at least one example embodiment, the numeric selection aspect relates to an interface element that provides for selection of a numerical value.

In at least one example embodiment, the numeric selection aspect relates to a slider interface element.

In at least one example embodiment, the numeric selection aspect relates to a scrollable set of selectable numeric enumerations.

In at least one example embodiment, the numeric selection aspect relates to a text entry interface element.

In at least one example embodiment, the interactive stylistic aspect relates to a navigation stylistic aspect.

In at least one example embodiment, the navigation stylistic aspect relates to a manner in which transition from a screen to a different screen is provided for.

In at least one example embodiment, the navigation stylistic aspect relates to a tabbed navigation aspect.

In at least one example embodiment, the tabbed navigation aspect relates to provision of a plurality of selectable tabs that govern a screen to be provided in response to selection of a selectable tab.

In at least one example embodiment, the navigation stylistic aspect relates to a virtual screen adjacency navigation aspect.

In at least one example embodiment, the virtual screen adjacency navigation aspect relates to provision of virtual screens such that panning beyond a boundary of a virtual screen causes transition to a different virtual screen.

In at least one example embodiment, the interactive stylistic aspect relates to a lock screen aspect.

In at least one example embodiment, the lock screen aspect relates to representation of information in a lock screen.

In at least one example embodiment, a lock screen relates to a screen that is provided after a lock event.

In at least one example embodiment, the lock screen aspect relates to representation of notification information associated with an enumerated set of programs.

In at least one example embodiment, the lock screen aspect relates to a lock screen program notification presentation aspect associated with a program.

In at least one example embodiment, the lock screen program notification presentation aspect relates to preclusion of a program icon from representing information indicative of a notification associated with the program.

In at least one example embodiment, the lock screen program notification presentation aspect relates to inclusion of a notification count, the notification count being indicative of a number of notification associated with the program.

In at least one example embodiment, the lock screen program notification aspect relates to inclusion of a notification count absent a representation of content of a notification associated with the program.

In at least one example embodiment, the lock screen program notification aspect relates to inclusion of a representation of content of a notification associated with the program.

In at least one example embodiment, the interactive stylistic aspect relates to an idle layout aspect.

In at least one example embodiment, the idle layout aspect relates to a manner in which program icons are arranged in an idle screen.

In at least one example embodiment, the idle layout aspect relates to a tiled icon layout.

In at least one example embodiment, the idle layout aspect relates to an icon grid layout.

In at least one example embodiment, the idle layout aspect governs at least one of, number of rows associated with the icon grid layout, or number of columns associated with the icon grid layout.

In at least one example embodiment, the interactive stylistic aspect relates to a gesture aspect.

In at least one example embodiment, the gesture aspect relates to an association between a predetermined gesture and an operation.

In at least one example embodiment, the association, the gesture, and the operation conform to the native interface style of the operating environment.

One or more example embodiments further perform determination of the interface style mimicry directive based, at least in part, on the native interface style of the operating environment of the apparatus.

One or more example embodiments further perform determination of at least one interface style setting based, at least in part, on the native interface style of the operating environment of the apparatus, wherein the interface style mimicry directive comprises information indicative of the interface style setting.

In at least one example embodiment, the interface style setting relates to a setting that configures a stylistic aspect of the native interface of the separate apparatus, the setting being unavailable for user modification by way of the native interface of the separate apparatus.

One or more example embodiments further perform receiving information indicative of an operating environment of the separate apparatus, wherein the determination of the interface style mimicry directive is based, at least in part, on the operating environment of the separate apparatus.

In at least one example embodiment, the information indicative of the operating environment of the separate apparatus is received from the separate apparatus.

In at least one example embodiment, the information indicative of the operating environment of the separate apparatus is received from a companionship facilitation server.

In at least one example embodiment, the determination of the interface style mimicry directive comprises determining information associated with modification of a native interface style of the operating environment of the separate apparatus to be similar to the native interface style of the operating environment of the apparatus.

In at least one example embodiment, the determination of the interface style mimicry directive is based, at least in part, on at least one interface style mimicry capability of the separate apparatus.

One or more example embodiments further perform retrieving, from memory, information indicative of the interface style mimicry capability of the separate apparatus.

One or more example embodiments further perform receiving information indicative of the interface style mimicry capability of the separate apparatus.

In at least one example embodiment, the information indicative of the interface style mimicry capability of the separate apparatus is received from the separate apparatus.

In at least one example embodiment, the information indicative of the interface style mimicry capability of the separate apparatus is received from a companionship facilitation server.

One or more example embodiments further perform receiving information indicative of a change of a non-stylistic setting associated with the separate apparatus, and causing change of a non-stylistic setting of the apparatus based, at least in part, on the information indicative of the change.

In at least one example embodiment, the non-stylistic setting of the apparatus corresponds with the non-stylistic setting of the separate apparatus.

In at least one example embodiment, the non-stylistic setting relates to at least one of an operational setting, an interaction option setting, an account setting, or a communication setting.

In at least one example embodiment, the operational setting relates to a setting that governs operations that are performed by an apparatus absent consideration of interaction associated with the operation.

In at least one example embodiment, the interaction option setting relates to a setting that governs a selection that pertains to a style independent aspect of a user interface.

In at least one example embodiment, the style independent aspect relates to an aspect that is configurable in the native interface style of an operating environment of the apparatus.

In at least one example embodiment, the style independent aspect relates to at least one of selection of a wallpaper image, an ordering of interface items, inclusion of at least one interface item in a set of interface items, or selection of an icon to be associated with a program.

In at least one example embodiment, the account setting relates to information associated with utilization of one or more accounts.

In at least one example embodiment, the account relates to at least one of an email account, a communication account, an instant messaging account, or a social networking account.

In at least one example embodiment, the communication account relates to at least one of a cellular communication account or a wireless communication profile.

In at least one example embodiment, the interface style mimicry directive specifies an operating system.

In at least one example embodiment, the interface style mimicry directive specifies an operating environment.

In at least one example embodiment, the interface style mimicry directive specifies a native interface style of an operating environment.

In at least one example embodiment, the interface style mimicry directive specifies at least one stylistic aspect of a native interface style.

One or more example embodiments further perform sending information indicative of an interface emulation program, associated with the native interface of the apparatus, to the separate apparatus.

One or more embodiments may provide an apparatus, a computer readable medium, a non-transitory computer readable medium, a computer program product, and a method for causing establishment of a communication channel between the an apparatus and a separate apparatus, identifying the separate apparatus as a primary apparatus to which the apparatus is a companion apparatus, receiving an interface style mimicry directive from the separate apparatus based, at least in part, on the identification of the primary apparatus, the interface style mimicry directive being a directive that instructs the apparatus to perform user interaction in compliance with the interface style mimicry directive absent control from the separate apparatus, causing termination of the communication channel, and performing user interaction in compliance with the interface style mimicry directive.

One or more embodiments may provide an apparatus, a computer readable medium, a computer program product, and a non-transitory computer readable medium having means for causing establishment of a communication channel between the an apparatus and a separate apparatus, means for identifying the separate apparatus as a primary apparatus to which the apparatus is a companion apparatus, means for receiving an interface style mimicry directive from the separate apparatus based, at least in part, on the identification of the primary apparatus, the interface style mimicry directive being a directive that instructs the apparatus to perform user interaction in compliance with the interface style mimicry directive absent control from the separate apparatus, means for causing termination of the communication channel, and means for performing user interaction in compliance with the interface style mimicry directive.

In at least one example embodiment, the interface style mimicry directive comprises information associated with modification of a native interface style of the apparatus to be similar to a native interface style of the separate apparatus.

In at least one example embodiment, the receipt of the interface style mimicry directive is predicated by the identification of the companion apparatus.

In at least one example embodiment, the apparatus is configured to execute an operating environment of the apparatus and the interface style mimicry directive relates to a native interface style of an operating environment of the separate apparatus that is different that the operating environment of the apparatus.

In at least one example embodiment, the operating environment of the apparatus relates to an operating system of the apparatus and the native interface style relates to a native interface style of the operating system.

In at least one example embodiment, a native interface style relates to at least one stylistic aspect of the interface style of the operating environment.

In at least one example embodiment, the stylistic aspect relates to an aspect of the interface style of the operating environment that is non-configurable by way of a setting of the operating environment.

In at least one example embodiment, the stylistic aspect relates to at least one interactive stylistic aspect.

In at least one example embodiment, the interactive stylistic aspect relates to a presentation stylistic aspect.

In at least one example embodiment, the interactive stylistic aspect relates to a program icon stylistic aspect.

In at least one example embodiment, the program icon stylistic aspect relates to at least one of icon shape, icon color palate, or icon border.

In at least one example embodiment, the program icon stylistic aspect relates to a program icon size variability aspect.

In at least one example embodiment, the program icon size variability aspect relates to an aspect that governs availability of a non-stylistic setting that governs size of a particular program icon.

In at least one example embodiment, the program icon stylistic aspect relates to a program icon notification presentation aspect.

In at least one example embodiment, the icon notification presentation aspect relates to preclusion of a program icon from representing information indicative of a notification associated with a program represented by the program icon.

In at least one example embodiment, the icon notification presentation aspect relates to inclusion of a notification count by a program icon, the notification count being indicative of a number of notification associated with a program represented by the program icon.

In at least one example embodiment, the icon notification aspect relates to inclusion of a notification count by a program icon absent a representation of content of a notification associated with a program represented by the program icon.

In at least one example embodiment, the icon notification aspect relates to inclusion of a representation of content of a notification associated with a program represented by the program icon.

In at least one example embodiment, the presentation stylistic aspect relates to an animation stylistic aspect.

In at least one example embodiment, the animation stylistic aspect governs one or more animations associated with one or more events in the operating environment.

In at least one example embodiment, the animation stylistic aspect governs a scroll animation.

In at least one example embodiment, the animation stylistic aspect governs presence of a bounce animation to signify a scroll endpoint.

In at least one example embodiment, the animation stylistic aspect governs a program open animation.

In at least one example embodiment, the animation stylistic aspect governs a program close animation.

In at least one example embodiment, the presentation stylistic aspect relates to a selection item aspect.

In at least one example embodiment, the selection item aspect governs a manner in which a selectable interface item is represented to a user.

In at least one example embodiment, the selection item aspect governs a radio button representation aspect.

In at least one example embodiment, the radio button representation aspect relates to an interface element that provides for selection of one of a set of enumerated options.

In at least one example embodiment, the radio button representation aspect relates to a selectable button representation.

In at least one example embodiment, the radio button representation aspect relates to a selectable enclosure representation.

In at least one example embodiment, the selectable enclosure representation relates to at least one of a selectable box or a selectable circle.

In at least one example embodiment, the selection item aspect governs a binary selection aspect.

In at least one example embodiment, the binary selection aspect relates to an interface element that provides for selection of one of two enumerated options.

In at least one example embodiment, the binary selection aspect relates to a slider interface element.

In at least one example embodiment, the binary selection aspect relates to a selectable toggle button representation.

In at least one example embodiment, the selection item aspect relates to a numeric selection aspect.

In at least one example embodiment, the numeric selection aspect relates to an interface element that provides for selection of a numerical value.

In at least one example embodiment, the numeric selection aspect relates to a slider interface element.

In at least one example embodiment, the numeric selection aspect relates to a scrollable set of selectable numeric enumerations.

In at least one example embodiment, the numeric selection aspect relates to a text entry interface element.

In at least one example embodiment, the interactive stylistic aspect relates to a navigation stylistic aspect.

In at least one example embodiment, the navigation stylistic aspect relates to a manner in which transition from a screen to a different screen is provided for.

In at least one example embodiment, the navigation stylistic aspect relates to a tabbed navigation aspect.

In at least one example embodiment, the tabbed navigation aspect relates to provision of a plurality of selectable tabs that govern a screen to be provided in response to selection of a selectable tab.

In at least one example embodiment, the navigation stylistic aspect relates to a virtual screen adjacency navigation aspect.

In at least one example embodiment, the virtual screen adjacency navigation aspect relates to provision of virtual screens such that panning beyond a boundary of a virtual screen causes transition to a different virtual screen.

In at least one example embodiment, the interactive stylistic aspect relates to a lock screen aspect.

In at least one example embodiment, the lock screen aspect relates to representation of information in a lock screen.

In at least one example embodiment, a lock screen relates to a screen that is provided after a lock event.

In at least one example embodiment, the lock screen aspect relates to representation of notification information associated with an enumerated set of programs.

In at least one example embodiment, the lock screen aspect relates to a lock screen program notification presentation aspect associated with a program.

In at least one example embodiment, the lock screen program notification presentation aspect relates to preclusion of a program icon from representing information indicative of a notification associated with the program.

In at least one example embodiment, the lock screen program notification presentation aspect relates to inclusion of a notification count, the notification count being indicative of a number of notification associated with the program.

In at least one example embodiment, the lock screen program notification aspect relates to inclusion of a notification count absent a representation of content of a notification associated with the program.

In at least one example embodiment, the lock screen program notification aspect relates to inclusion of a representation of content of a notification associated with the program.

In at least one example embodiment, the interactive stylistic aspect relates to an idle layout aspect.

In at least one example embodiment, the idle layout aspect relates to a manner in which program icons are arranged in an idle screen.

In at least one example embodiment, the idle layout aspect relates to a tiled icon layout.

In at least one example embodiment, the idle layout aspect relates to an icon grid layout.

In at least one example embodiment, the idle layout aspect governs at least one of, number of rows associated with the icon grid layout, or number of columns associated with the icon grid layout.

In at least one example embodiment, the interactive stylistic aspect relates to a gesture aspect.

In at least one example embodiment, the gesture aspect relates to an association between a predetermined gesture and an operation.

In at least one example embodiment, the association, the gesture, and the operation conform to the native interface style of the operating environment.

One or more example embodiments further perform determining at least one interface style setting based, at least in part, on the native interface style of the operating environment of the apparatus and the interface style mimicry directive, wherein the interface style setting governs a stylistic aspect that differs between the native interface style of the operating environment of the apparatus and the interface style mimicry directive.

In at least one example embodiment, the interface style setting relates to a setting that configures a stylistic aspect of the native interface of the apparatus, the setting being unavailable for user modification by way of the native interface of the apparatus.

One or more example embodiments further perform causation of sending information indicative of an operating environment of the apparatus.

In at least one example embodiment, the information indicative of the operating environment of the apparatus is sent to the separate apparatus.

In at least one example embodiment, the information indicative of the operating environment of the apparatus is sent to a companionship facilitation server.

One or more example embodiments further perform causation of sending information indicative of an interface style mimicry capability of the apparatus.

In at least one example embodiment, the information indicative of the interface style mimicry capability of the apparatus is retrieved from memory of the apparatus.

In at least one example embodiment, the information indicative of the interface style mimicry capability of the separate apparatus is received from a companionship facilitation server.

In at least one example embodiment, the interface style mimicry capability is based, at least in part, on availability of an interface emulation program for the apparatus to emulate, at least one stylistic aspect, indicated by the interface style mimicry capability.

One or more example embodiments further perform receiving information indicative of a change of a non-stylistic setting associated with the separate apparatus, and causing change of a non-stylistic setting of the apparatus based, at least in part, on the information indicative of the change.

In at least one example embodiment, the non-stylistic setting of the apparatus corresponds with the non-stylistic setting of the separate apparatus.

In at least one example embodiment, the non-stylistic setting relates to at least one of an operational setting, an interaction option setting, an account setting, or a communication setting.

In at least one example embodiment, the operational setting relates to a setting that governs operations that are performed by an apparatus absent consideration of interaction associated with the operation.

In at least one example embodiment, the interaction option setting relates to a setting that governs a selection that pertains to a style independent aspect of a user interface.

In at least one example embodiment, the style independent aspect relates to an aspect that is configurable in the native interface style of an operating environment of the apparatus.

In at least one example embodiment, the style independent aspect relates to at least one of selection of a wallpaper image, an ordering of interface items, inclusion of at least one interface item in a set of interface items, or selection of an icon to be associated with a program.

In at least one example embodiment, the account setting relates to information associated with utilization of one or more accounts.

In at least one example embodiment, the account relates to at least one of an email account, a communication account, an instant messaging account, or a social networking account.

In at least one example embodiment, the communication account relates to at least one of a cellular communication account or a wireless communication profile.

In at least one example embodiment, the interface style mimicry directive specifies an operating system, and performance of user interaction in compliance with the interface style mimicry directive comprises determination of at least one stylistic setting associated with a native interface of the operating system.

In at least one example embodiment, the interface style mimicry directive specifies an operating environment that differs from an operating environment of the apparatus.

In at least one example embodiment, the interface style mimicry directive specifies an interface style of an operating environment that differs from a native interface style of the operating environment of the apparatus.

In at least one example embodiment, the interface style mimicry directive specifies at least one stylistic aspect that differs from at least one stylistic aspect of a native interface style of the apparatus.

In at least one example embodiment, performance of user interaction in compliance with the interface style mimicry directive comprises execution of an interface emulation program that causes the apparatus to emulate, at least one stylistic aspect, indicated by the interface style mimicry directive.

One or more example embodiments further perform selection of the interface emulation program based, at least in part, on the interface style mimicry directive.

In at least one example embodiment, selection is based, at least in part, an enumeration of available interface emulation programs, and the enumeration of available interface emulation programs comprises an indication of the interface emulation program.

One or more example embodiments further perform receipt of the enumeration of available interface emulation programs and the interface emulation program.

One or more example embodiments further perform receipt of the interface emulation program.

In at least one example embodiment, the interface emulation program is received from the separate apparatus.

In at least one example embodiment, the interface style mimicry directive comprises information indicative of the interface emulation program.

In at least one example embodiment, the interface style mimicry directive comprises the interface emulation program.

In at least one example embodiment, the interface emulation program is received from a companionship facilitation server.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to an example embodiment;

FIGS. 2A-2B are diagrams illustrating apparatus communication according to at least one example embodiment;

FIGS. 3A-3D are diagrams illustrating program icons according to at least one example embodiment;

FIGS. 4A-4D are diagrams illustrating parts of animations according to at least one example embodiment;

FIGS. 5A-5B are diagrams illustrating radio button representations according to at least one example embodiment;

FIGS. 6A-6C are diagrams illustrating binary selection according to at least one example embodiment;

FIGS. 7A-7C are diagrams illustrating numeric selection according to at least one example embodiment;

FIGS. 8A-8B are diagrams illustrating navigation according to at least one example embodiment;

FIGS. 9A-9B are diagrams illustrating idle layout according to at least one example embodiment;

FIGS. 10A-10C are diagrams illustrating lock screens according to at least one example embodiment;

FIG. 11 is an interaction diagram showing activities associated with interface style mimicry according to at least one example embodiment;

FIG. 12 is a flow diagram illustrating activities associated with causation of stylistic mimicry on a companion apparatus according to at least one example embodiment;

FIG. 13 is a flow diagram illustrating activities associated with causation of stylistic mimicry on a companion apparatus according to at least one example embodiment;

FIG. 14 is a flow diagram illustrating activities associated with causation of stylistic mimicry on a companion apparatus according to at least one example embodiment;

FIG. 15 is an interaction diagram showing activities associated with interface style mimicry according to at least one example embodiment;

FIG. 16 is a flow diagram illustrating activities associated with causation of stylistic mimicry on a companion apparatus according to at least one example embodiment;

FIG. 17 is an interaction diagram showing activities associated with interface style mimicry according to at least one example embodiment;

FIG. 18 is an interaction diagram showing activities associated with interface style mimicry according to at least one example embodiment;

FIG. 19 is a flow diagram illustrating activities associated with causation of stylistic mimicry on a companion apparatus according to at least one example embodiment; and

FIG. 20 is an interaction diagram showing activities associated with interface style mimicry according to at least one example embodiment.

### DETAILED DESCRIPTION OF THE DRAWINGS

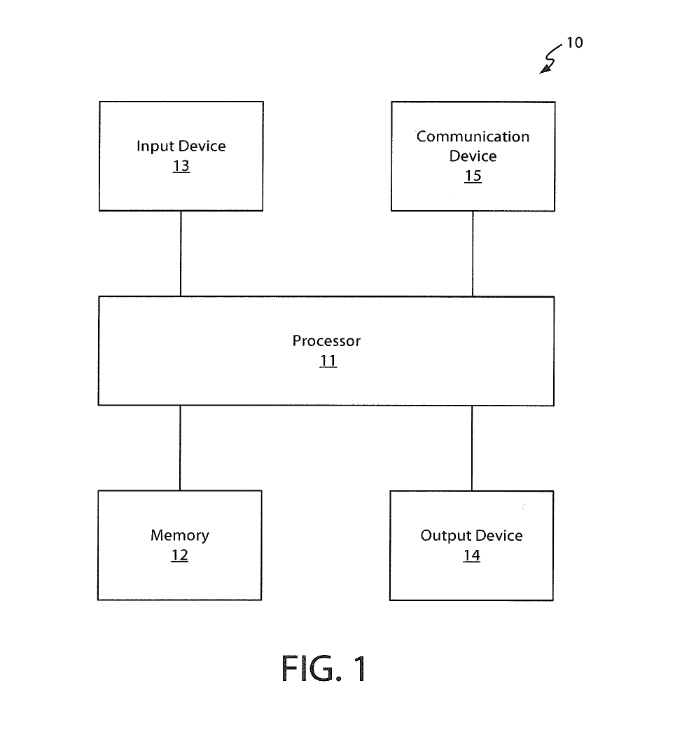

An embodiment of the invention and its potential advantages are understood by referring to FIGS. 1 through 20 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a portable digital assistant (PDAs), a pager, a mobile computer, a desktop computer, a television, a gaming apparatus, a laptop computer, a media player, a camera, a video recorder, a mobile phone, a global positioning system (GPS) apparatus, and/or any other types of electronic systems.

Moreover, the apparatus of at least one example embodiment need not be the entire electronic apparatus, but may be a component or group of components of the electronic apparatus in other example embodiments.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like.

In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like.

In at least one example embodiment, the apparatus receives an indication of an input. The apparatus may receive the indication from a sensor, a driver, a separate apparatus, and/or the like. The information indicative of the input may relate to information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

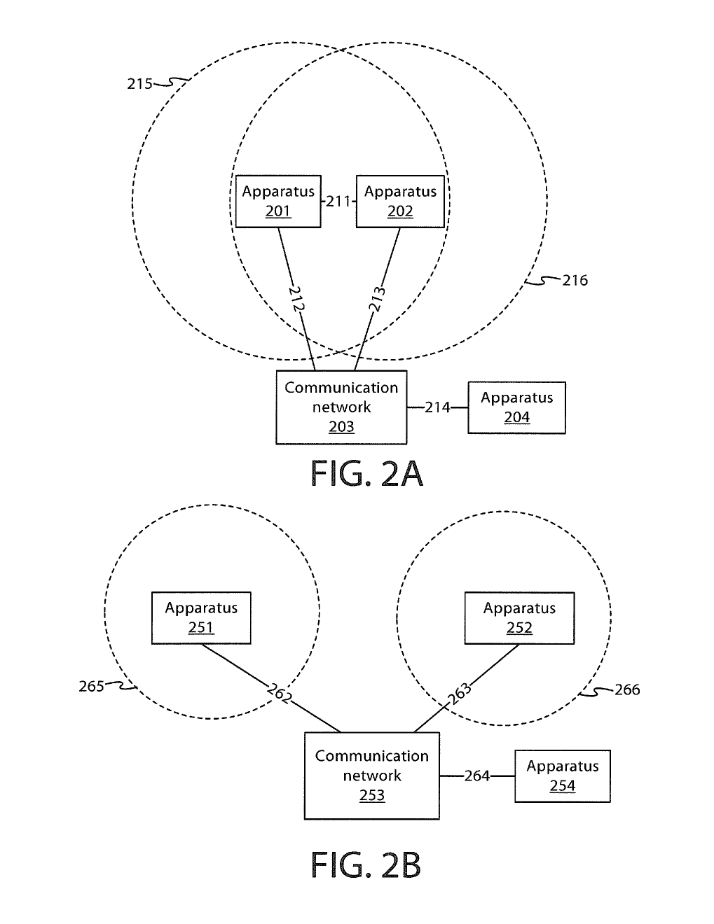

FIGS. 2A-2B are diagrams illustrating apparatus communication according to at least one example embodiment. The examples of FIGS. 2A-2B are merely examples of apparatus communication, and do not limit the scope of the claims. For example, proximity of the apparatuses may vary, type of communication may vary, communication path between apparatuses may vary, and/or the like.

As electronic apparatuses have become more prolific, there has been an increasing desire for users to utilize multiple electronic apparatuses collaboratively. For example, a user may have a plurality of electronic apparatuses. In such an example, the user may desire to share information from an electronic apparatus to another electronic apparatus, to transfer control of a resource from an electronic apparatus to another electronic apparatus, to have an electronic apparatus authorize another electronic apparatus to perform an action associated with the electronic apparatus, and/or the like. For example, the user may have content stored on an apparatus and desire to send a copy of the content to another apparatus. In such an example, the other apparatus may be the user's apparatus or a different user's apparatus. In another example, a user may have multiple communication apparatuses and desire to route communication from a communication apparatus to another communication apparatus. For example, the user may desire to forward calls from the apparatus to the other apparatus.

In some circumstances, a user may desire to have collaboration between apparatuses based on their proximity with each other. For example, it may be intuitive for a user to manage collaboration between apparatuses that are local to each other. A plurality of apparatuses may be proximate to each other based on location, availability of local communication among the apparatuses, and/or the like. For example, if the apparatuses collaborate by way of near field communication, Bluetooth, infrared, local area network, wireless local area network, and/or the like, the apparatuses may be considered to be proximate with each other based, at least in part, on availability of such proximity-based communication with each other.

As users become more accustomed to utilizing multiple apparatuses, the activities that the users perform have become increasingly important to the users. For example, in some circumstances, the activity being performed may be more important to the user than the apparatus that is utilized to perform the activity. For example, the user may desire to perform an activity, but may select an apparatus or a different apparatus to utilize in performing the activity based on a secondary consideration, such as appearance of the apparatus, mobility of the apparatus, other capabilities of the apparatus that do not necessarily pertain to the activity, and/or the like. In some circumstances, the user may not necessarily prefer use of the apparatus over use of the different apparatus. For example, the user may merely utilize an apparatus to perform an activity, instead of the different apparatus, based on coincidence, proximity to the user, and/or the like.

In some circumstances, a user may desire to utilize apparatuses interchangeably with each other. For example, the user may predominantly utilize a primary apparatus, but may desire to utilize a different apparatus, instead of the primary apparatus, on certain occasions. For example, the user may prefer the primary apparatus under some circumstances, and desire the different apparatus in other circumstances. In such an example, a user may desire an apparatus with a large display under some circumstances, and desire an apparatus with a small display in other circumstances. The user may desire to vary which apparatus to use based on apparatus capability, apparatus form factor, apparatus size, fashion suitability of an apparatus, and/or the like.

In this manner, it may be desirable for a user to utilize multiple apparatuses interchangeably as desired to accommodate varying circumstances. The user may desire interchangeability such that the activities that the user performs with a primary apparatus may be similarly performed on the different apparatus. For example, the user may desire to access the same email accounts on both apparatuses, see the same content on both apparatuses, communicate by way of the same communication accounts on both apparatuses, and/or the like. For example, a user may desire to perform phone calls associated with a particular phone number when using either apparatus. In this manner, it may be desirable for such apparatuses to utilize similar settings and configuration.

In at least one example embodiment, companion apparatuses relate to apparatuses that collaborate settings with each other. Such collaboration may take place to allow a user to utilize companion apparatuses interchangeably, as described above. For example, a companion apparatus may be an apparatus that automatically communicates with another companion apparatus for purposes such as synchronizing data, exchanging status information, and/or the like. In at least one example embodiment, an apparatus retains information associated with communication with the companion apparatus. For example, the apparatus may comprise information associated with identifying, communicating with, authenticating, performing authentication with, and/or the like, the companion apparatus. In this manner, the apparatus may be privileged to perform secure operations in conjunction with the companion apparatus that a different apparatus may lack the privilege to perform.

In at least one example embodiment, the apparatus comprises information indicative of the identity of the companion apparatus. In at least one example embodiment, an apparatus may store information that allows the apparatus to identify another apparatus as a companion apparatus. For example, the apparatus may identify a companion apparatus by way of an identifier, such as a serial number, and address, such as a media access control (MAC) address, an assigned identifier, and/or the like. For example, an apparatus and another apparatus may perform a companionship establishment session that establishes a companionship relationship between the apparatus and the other apparatus. In such circumstances the apparatus and the other apparatus may exchange information that allows for identification. For example, the apparatus may receive identification information from the other apparatus, may assign identification information to the other apparatus, may provide identification information to the other apparatus, and/or the like. In at least one example embodiment, an apparatus may predicate treatment of another apparatus on successful identification of the other apparatus as a companion apparatus. For example, the apparatus may preclude synchronization of, at least some, information with the other apparatus in circumstances where the apparatus fails to identify the other apparatus as a companion apparatus.

In at least one example embodiment, an apparatus comprises information associated with communicating with a companion apparatus. In at least one example embodiment, communication based, at least in part, on short range communication is referred to as proximity-based communication. In at least one example embodiment, proximity-based communication relates to wireless communication that is associated with a short range, such as near field communication, Bluetooth, infrared, and/or the like. In such an example the exchange of information may be by way of the short range wireless communication between the apparatus and the other apparatus.

In some circumstances, proximity-based communication may relate to communication between apparatuses using a short range communication channel In some circumstances, proximity-based communication may relate to communication between apparatuses using a communication channel that is not necessarily a short range communication channel In such circumstances, the utilization of the communication channel may be predicated upon availability of a short range communication channel. For example, an apparatus may utilize a short range communication channel to obtain information associated with communication across a different communication channel. For example, an apparatus may utilize short range communication with another apparatus to obtain address information for the other apparatus. In such an example, the apparatus may utilize the address information to communicate with the other apparatus by way of a different communication channel, such as a different short range communication channel, a communication channel that is not a short range communication channel, and/or the like. In at least one example embodiment, a communication channel relates to, at least partially, allocation of communication resources between an apparatus and another apparatus. For example, a communication channel may relate to a frequency designation, a channel designation, a sub-channel designation, a frame designation, and/or the like. An apparatus may have a plurality of communication channels. For example, an apparatus may have one or more communication channels with one or more other apparatuses, with one or more communication networks, and/or the like. For purposes of clarity, a communication channel may be referred to in terms of an apparatus involved in the communication channel. For example, a communication channel associated with an apparatus may be referred to as an apparatus communication channel, a communication channel associated with a separate apparatus may be referred to as a separate apparatus communication channel, a communication channel associated with a communication network may be referred to as a communication network communication channel, and/or the like.

In at least one example embodiment, an apparatus may be involved in establishment of a communication channel. For example, there may be various actions that an apparatus may take for a communication channel to become existent between the apparatus and another apparatus, a communication network, and/or the like. After a communication channel is established, the communication channel may be utilized for communication. In at least one example embodiment, an apparatus may be involved in termination of a communication channel. For example, there may be various actions that an apparatus may take for a communication channel to become non-existent between the apparatus and another apparatus, a communication network, and/or the like. After a communication channel is terminated, the communication channel may be unavailable for communication. In at least one example embodiment, existence of a communication channel between an apparatus and another apparatus is indicative of the apparatus being in communication with the other apparatus.

In at least one example embodiment, an apparatus receives an indication of availability of proximity-based communication with a separate apparatus. The indication of availability may relate to information indicating that the other apparatus is within range of a short range communication, an indication that the other apparatus is present on a short range communication network, and/or the like. In at least one example embodiment, the apparatus determines that the other apparatus is unavailable for proximity-based communication by way of absence of information indicative of availability of the proximity-based communication.

In the example of FIG. 2A, apparatus 201 and apparatus 202 may collaborate locally. In some circumstances, apparatus 201 and apparatus 202 may communicate directly with each other, such as by way of proximity-based communication, by way of communication channel 211. In the example of FIG. 2A, the proximity-based communication range of apparatus 201 is indicated by region 215 and the proximity-based communication range of apparatus 202 is indicated by region 216. In some circumstances, apparatus 201 may communicate with apparatus 202 by way of communication network 203. For example, communication network 203 may be an intermediary apparatus such that apparatus 201 and apparatus 202 may communicate with each other by way of communication channels 212 and 213, may be a group of apparatuses in communication with each other such that apparatus 201 and apparatus 202 may communicate with each other by way of communication channels 212 and 213, and/or the like. In some circumstances, apparatus 201 may obtain information from apparatus 202, by way of communication channel 211, that allows apparatus 201 to communicate with apparatus 202 by way of communication network 203. In some circumstances, apparatus 201 and/or apparatus 202 may communicate with apparatus 204 by way of communication network 203. For example, communication network 203 may be an intermediary apparatus such that apparatus 201 and apparatus 204 may communicate with each other by way of communication channels 212 and 214, may be a group of apparatuses in communication with each other such that apparatus 201 and apparatus 204 may communicate with each other by way of communication channels 212 and 214, and/or the like. In another example, communication network 203 may be an intermediary apparatus such that apparatus 202 and apparatus 204 may communicate with each other by way of communication channels 212 and 214, may be a group of apparatuses in communication with each other such that apparatus 202 and apparatus 204 may communicate with each other by way of communication channels 213 and 214, and/or the like.

In the example of FIG. 2A apparatus 201 may determine that apparatus 202 is proximate based, at least in part, on availability of proximity-based communication 211, by way of communicating with the same communication apparatus of communication network 203, by way of comparing position information of apparatus 201 and position information of apparatus 202, and/or the like.

In the example of FIG. 2B, apparatus 251 and apparatus 252 may communicate with each other by way of communication network 253. Apparatus 251 may be in communication with communication network 253 by way of communication channel 262. Apparatus 252 may be in communication with communication network 253 by way of communication channel 263. In the example of FIG. 2C, the proximity-based communication range of apparatus 251 is indicated by region 265 and the proximity-based communication range of apparatus 252 is indicated by region 266. It can be seen that apparatus 252 is unavailable for proximity-based communication with apparatus 251. In some circumstances, apparatus 251 may communicate with apparatus 252 by way of communication network 253. In the example of FIG. 2C, apparatus 251 may determine that apparatus 252 is not proximate to apparatus 251 based, at least in part on unavailability of proximity-based communication with apparatus 252. In some circumstances, apparatus 251 and/or apparatus 252 may communicate with apparatus 254 by way of communication network 253. For example, communication network 253 may be an intermediary apparatus such that apparatus 251 and apparatus 254 may communicate with each other by way of communication channels 262 and 264, may be a group of apparatuses in communication with each other such that apparatus 251 and apparatus 254 may communicate with each other by way of communication channels 262 and 264, and/or the like. In another example, communication network 253 may be an intermediary apparatus such that apparatus 252 and apparatus 254 may communicate with each other by way of communication channels 262 and 264, may be a group of apparatuses in communication with each other such that apparatus 252 and apparatus 254 may communicate with each other by way of communication channels 263 and 264, and/or the like.

In at least one example embodiment, a communication network relates to one or more apparatuses that provide for communication between an apparatus and another apparatus.

For example, the communication network may comprise a plurality of communication apparatuses. A communication apparatus may be any apparatus associated with facilitation of communication in a communication network. For example, a communication apparatus may relate to an access point for the communication network, such as a wireless access point, a cellular base station, a Bluetooth access point, and/or the like. In another example, a communication network apparatus may relate to an apparatus utilized for communication within the communication network, such as a hub, a router, a switch, and/or the like. In at least one example embodiment, an apparatus may be in communication with a communication network by way of a communication channel with a communication apparatus of the communication network. In at least one example embodiment, an apparatus that does not have a communication channel with a communication apparatus may not be in communication with the communication apparatus. In some circumstances, an apparatus and another apparatus may communicate by way of a communication network by way of the same communication apparatus. For example, an apparatus may communicate with another apparatus, by way of a cellular network, where the apparatus and the other apparatus are in communication with the same base station of the cellular network. In such an example, the apparatus and the other apparatus may be within a region that is covered by the base station.

It may further be desirable for a user to be able to utilize such apparatuses interchangeably without performing laborious or time consuming activities to transition from utilization of a companion apparatus and a different companion apparatus. For example, the user may reach a decision to utilize the companion apparatus instead of the different companion apparatus as the user is leaving home. In such circumstances, the user may desire to merely take the companion apparatus instead of the different companion apparatus, without necessarily interacting with either apparatus. In this manner, it may be desirable for a companion apparatus to send information to another companion apparatus on a periodic basis. Such periodic interaction may be automatic, and/or independent of receipt of an indication of a user input to provoke such interaction.

To facilitate interchangeable utilization, there may be various settings, content, and other information that may be exchanged between companion apparatuses. For example, if a user takes a photograph with an apparatus, the apparatus may send the photograph to a companion apparatus. In this manner, the user may be able to rely on mere acquisition of the photograph to be able to access the photograph on the apparatus or the companion apparatus.

There may be many types of information and/or settings that are exchanged between an apparatus and a companion apparatus. For example, the apparatus may send, to a companion apparatus, information indicative of an operational setting, an account setting, a communication setting, and/or the like. An operational setting may relate to a setting that governs one or more operations that are performed by an apparatus absent consideration of interaction associated with the operation. For example, the operational setting may relate to a communication setting, a power management setting, a program utilization setting, and/or the like. An account setting may relate to information associated with utilization of one or more accounts. For example, an account setting may relate to an email account, a communication account, an instant messaging account, a social networking account, and/or the like. A communication account may relate to a cellular communication account, a wireless communication profile, and/or the like, in relation to a wireless communication network, a wired communication network, a wireless communication channel, a wired communication channel, and/or the like.

There may be many different operating environments that an apparatus may utilize. In at least one example embodiment, an operating environment relates to a part of apparatus software that governs a user interface of the apparatus. The apparatus may be configured to execute an operating environment of the apparatus, for example, by way of comprising computer program instructions associated with the operating environment. For example, the operating environment may pertain to the graphical user interface of the apparatus, a text entry interface of the apparatus, a gesture interface of the apparatus, and/or the like. In some circumstances, the operating environment of the apparatus may depend upon the operating system of the apparatus. For example, the apparatus may utilize an operating system that provides for one or more operating environments. For example, an operating system may provide for an enhanced graphical user interface and provide for a low-resource graphical user interface. In such an example, the operating system may provide for an operating environment associated with the enhanced graphical user interface and/or provide for a different operating environment associated with the low-resource graphical user interface. In some circumstances, the operating system may provide a single operating environment. In this manner, the native interface style of the operating environment may be the native interface style of the operating system.

In many circumstances, an operating environment has a native interactive style. In at least one example embodiment, a native interactive style relates to the manner in which an operating environment is designed to interact with a user. For example, the native interface style of the operating environment may relate to a look and feel that the designer of the operating environment desires the user to experience.

Such native interface style may comprise portions that are stylistic, and portions that are non-stylistic. In at least one example embodiment, a non-stylistic portion of a native interface style relates to an aspect of the operating environment that is configurable by way of an operating environment setting. For example, the operating environment may provide settings that allow a user to change a wallpaper, to change a ringtone, to change order of icons on a screen, and/or the like. In at least one example embodiment, a stylistic portion of the native interface style relates to an aspect of the native interface style of the operating environment that is non-configurable by way of a setting of the operating environment. Such aspects may be referred to as stylistic aspects. For example, a stylistic aspect may relate to the way an icon looks, the way a user navigates to a different screen, and/or the like.

In at least one example embodiment, the apparatus sends, to a companion apparatus, information indicative of an interaction option setting. An interaction option setting may relate to a setting that governs a selection that pertains to a style independent aspect of a user interface. In at least one example embodiment, a style independent aspect relates to an aspect of a user interface that is configurable in a native interface style of an operating environment of the apparatus. For example, a style independent aspect may relate to selection of a wallpaper image, an ordering of interface items, inclusion of at least one interface item in a set of interface items, selection of an icon to be associated with a program, selection of audio to be played in response to an event, a color selection from a color palate, a representation theme selection, and/or the like. A setting that governs a style independent aspect of a user interface may be referred to as a non-stylistic setting.

In some circumstances, there may be many differences in the manner in which an operating environment impacts the user's experience with the apparatus. For example, a user may become highly accustomed to a particular native interface style of an operating environment. In some circumstances, the user may become so accustomed to the native interface style of an operating environment that it may become difficult for the user to be similarly productive when interacting with a different interface style. For example, a user may be adept when performing actions associated with a particular interface style, but may find a different interface style uncomfortable, or problematic. Such circumstances may cause confusion and delay for the user. For at least this reason, it may be desirable for a companion apparatus to mimic the interface style of another companion apparatus. In this manner, the user may be able to experience a greater level of interchangeability between the companion apparatuses by way of similarity between the interface styles of the companion apparatuses. Therefore, the user may be less likely to be confused or delayed when using an apparatus that has a different native interface style than the companion apparatus that the user has become accustomed to using. Consequently, a user may benefit from an increase in similarity between interface styles of companion apparatuses.

In at least one example embodiment, a companion apparatus may cause another companion apparatus to mimic, at least a portion, of the native interface style of the apparatus.

In at least one example embodiment, a companion apparatus may be configured to mimic a native interface style of another companion apparatus. In at least one example embodiment, an apparatus that causes another apparatus to mimic a native interface style of the apparatus may be referred to as a primary apparatus. However, it should be understood that this term is utilized merely to allow for designation of the role of the apparatus in interface style mimicry, and does not necessarily limit the claims in any way. For example, the term primary may be unassociated with the frequency with which the user utilizes the apparatus, the capabilities of the apparatus, and/or the like.

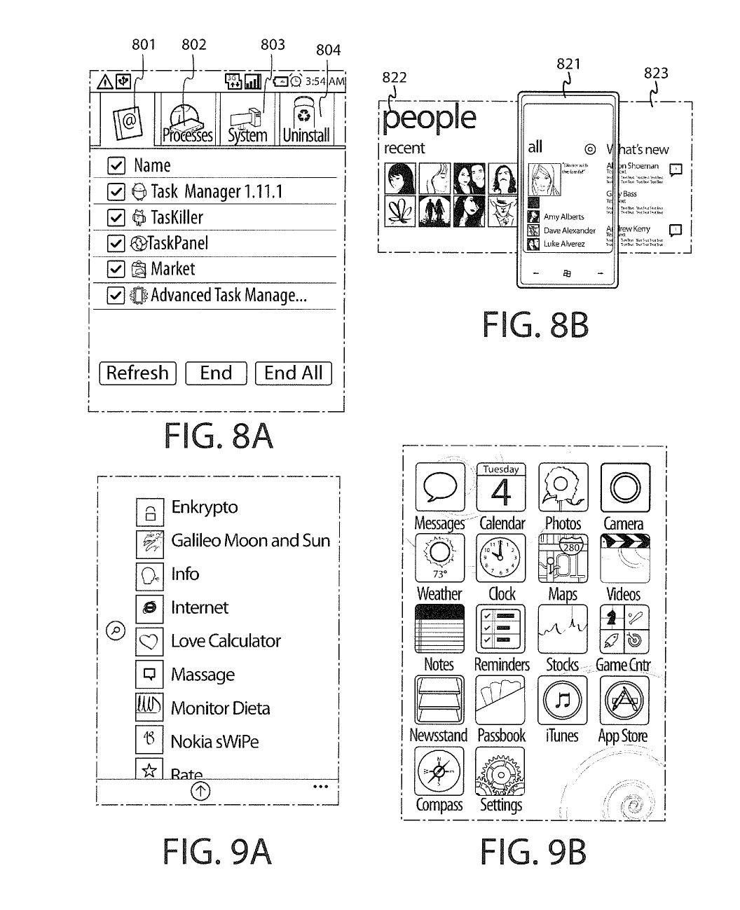

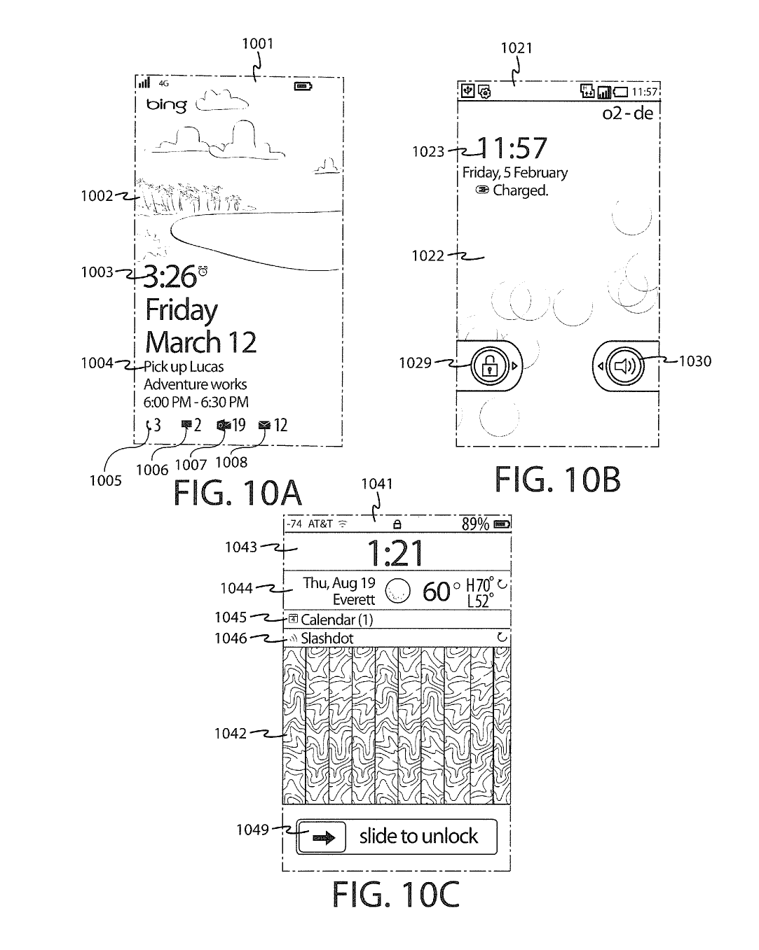

In at least one example embodiment, a native interface style relates to at least one stylistic aspect of the interface style of the operating environment. For example, the stylistic aspect may relate to an aspect of the native interface style of the operating environment that is non-configurable by way of a setting of the operating environment. In at least one example embodiment, a stylistic setting fails to pertain to a non-stylistic aspect. In at least one example embodiment, the stylistic aspect relates to at least one interactive stylistic aspect. An interactive stylistic aspect of the native interface style of an operating environment may pertain to the manner in which stylistic elements of the native interface style of the operating environment are provided and/or performed. In at least one example embodiment, the interactive stylistic aspect relates to a navigation stylistic aspect, similarly as described regarding FIGS. 8A-8B, relates to a lock screen aspect, similarly as described regarding FIGS. 10A-10B, relates to an idle layout aspect, similarly as described regarding FIGS. 9A-9B, relates to a presentation stylistic aspect, and/or the like.

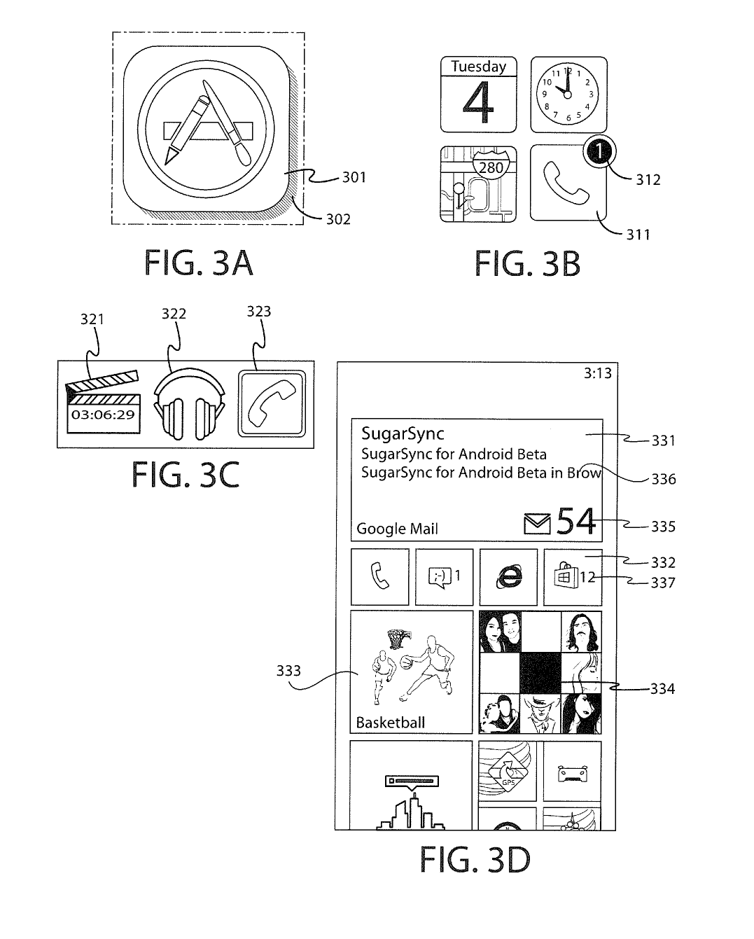

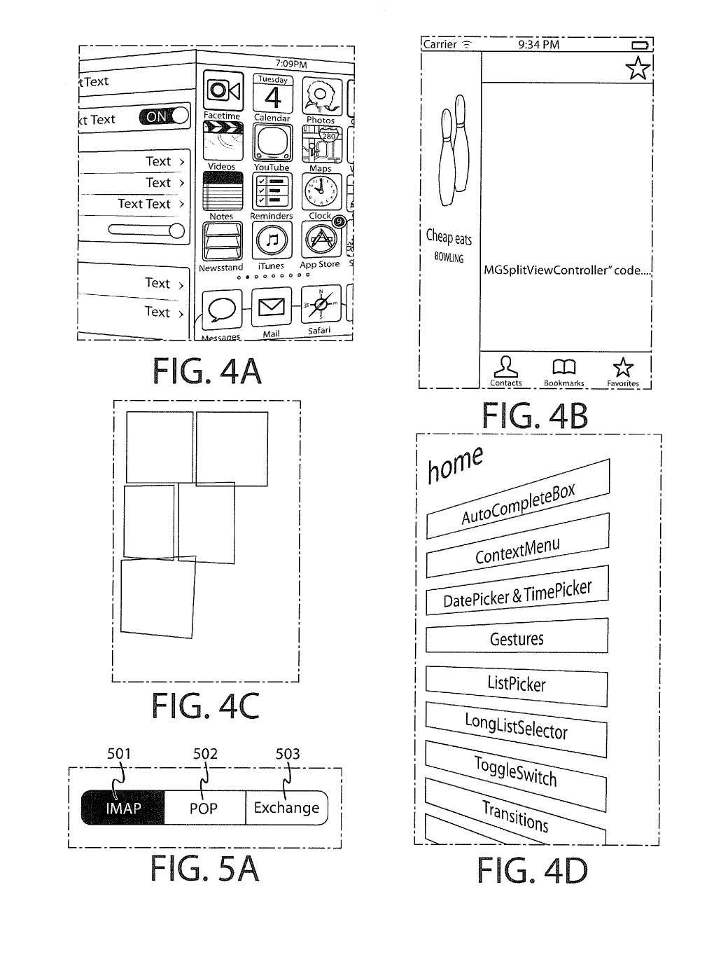

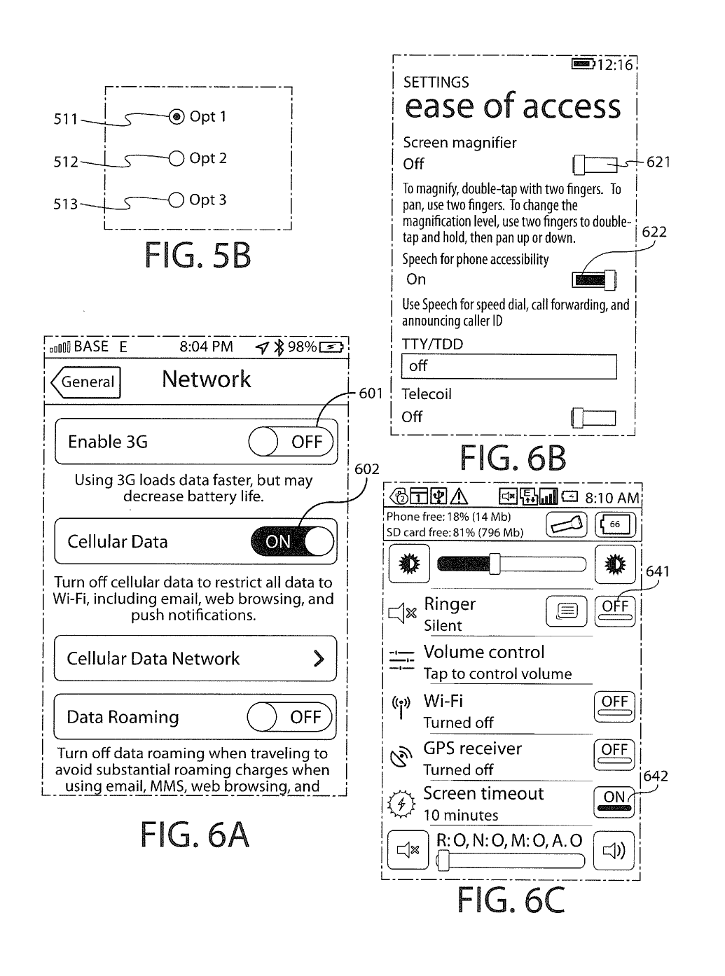

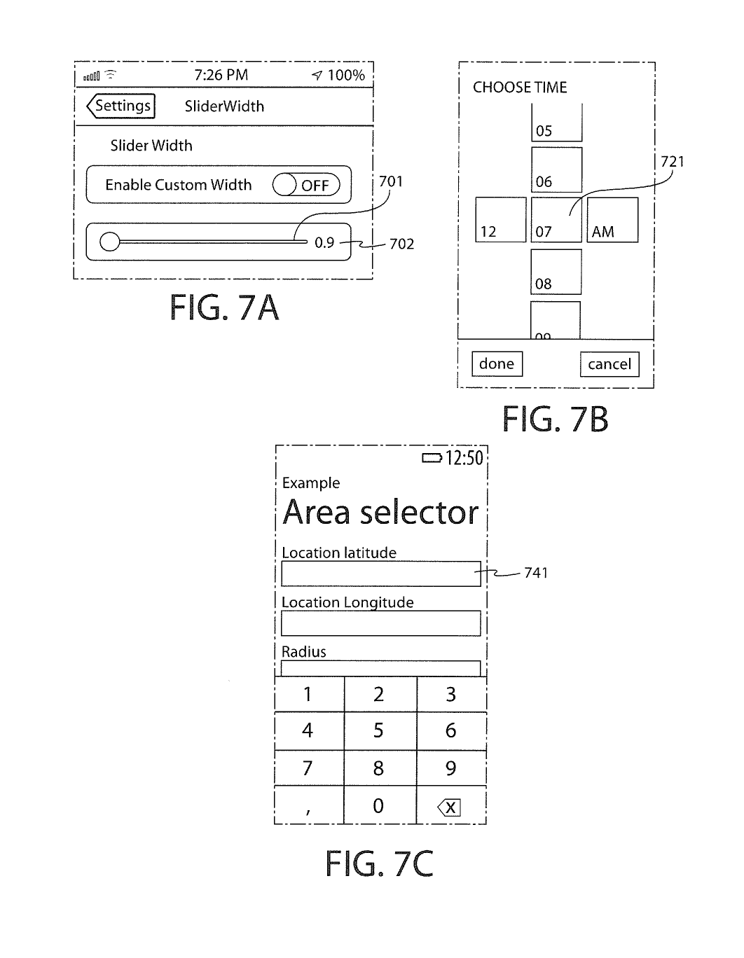

A presentation stylistic aspect may relate to a visual manner in which information is provided to the user. For example, the interactive stylistic aspect may relate to a program icon stylistic aspect, similarly as described regarding FIGS. 3A-3D, may relate to an animation stylistic aspect, similarly as described regarding FIGS. 4A-4D, may relate to a selection item aspect, and/or the like. In at least one example embodiment, a selection item aspect governs a manner in which a selectable interface item is represented to a user. A selectable interface item may relate to an interface item that a user may utilize to provide a value to the apparatus. For example, the selection item aspect may govern a radio button representation aspect, similarly as described regarding FIGS. 5A-5B, may govern a binary selection aspect, similarly as described regarding FIGS. 6A-6C, may govern a numeric selection aspect, similarly as described regarding FIGS. 7A-7C, and/or the like.

In at least one example embodiment, a primary apparatus may cause a companion apparatus to interact with a user in the native interface style of the primary apparatus. For example, a native interface style of the operating environment of the primary apparatus may be different from a native interface style of the operating environment of the companion apparatus. In such an example, the primary apparatus may cause the companion apparatus to interact with the user in accordance with the native interface style of the primary apparatus.

In at least one example embodiment, the companion apparatus interacts with the user in accordance with at least one stylistic aspect that differs from a stylistic aspect of the native interface style of the companion apparatus based, at least in part, on an interface style mimicry directive. In at least one example embodiment, the interface style mimicry directive relates to a directive that instructs the separate apparatus to perform user interaction in compliance with the interface style mimicry directive absent control from the apparatus. The interface style mimicry directive may comprise information associated with modification of a native interface style of a companion apparatus to be similar to a native interface style of a primary apparatus. The interface style mimicry directive may be a message, a signal, and/or the like, that is received by a companion apparatus that conveys information indicative of an interface style to be mimicked. For example, the interface style mimicry directive may specify an operating system, may specify an operating environment, may specify a native interface style of an operating environment, may specify at least one stylistic aspect of a native interface style, and/or the like. In some circumstances, the interface style mimicry directive may specify an operating system that differs from the operating system of the companion apparatus, may specify an operating environment that differs from the operating environment of the companion apparatus, may specify a native interface style of an operating environment that differs from the native interface style of an operating environment of the companion apparatus, may specify at least one stylistic aspect of a native interface style that differs from at least one stylistic aspect of a native interface style of the companion apparatus, and/or the like.

In at least one example embodiment, a companion apparatus performs user interaction in compliance with the interface style mimicry directive. Performance of user interaction in compliance with the interface style mimicry directive may relate to altering at least one stylistic aspect of the native interface style of the companion apparatus to be similar to at least one stylistic aspect indicated by the interface style mimicry directive. For example, the companion apparatus may comprise an interface emulation program that causes the companion apparatus to emulate at least one stylistic aspect indicated by the interface style mimicry directive. In at least one example embodiment, an interface emulation program relates to a program that interacts with an operating environment to provide for user interaction instead of, at least a portion of, the user interface of the operating environment. For example, the interface emulation program may cause display of interface elements to the user, may interpret input received from a user, and/or the like. The companion apparatus may perform user interaction in compliance with the interface style mimicry directive absent monitoring by the primary apparatus. For example, the companion apparatus may internally alter its interface style to conform to the interface style mimicry directive absent any ongoing control or communication from the primary apparatus. In this manner, the companion apparatus may perform user interaction in compliance with the interface style mimicry directive absent concurrent communication with the primary apparatus.

In at least one example embodiment, the primary apparatus may base the interface style mimicry directive, at least in part, on identification of the companion apparatus. For example, the primary apparatus may predicate sending of the interface style mimicry directive to a separate apparatus upon identification of the separate apparatus as a companion apparatus. Such identification may relate to identification of the companion apparatus during creation of the companionship relationship, during exchange of information between the primary apparatus and the companion apparatus, and/or the like. For example, a user may designate a companion apparatus to be a primary apparatus, for purposes of native interface style. In such an example, the primary apparatus may determine to send an interface style mimicry directive to one or more companion apparatuses with which the primary apparatus communicates. In at least one example embodiment, the primary apparatus may base the interface style mimicry directive, at least in part, on the native interface style of the primary apparatus. Such basis may relate to an introspective query to an operating system to determine information associated with the native interface style, may relate to retrieval of stored information indicative of the native interface style, and/or the like.

In at least one example embodiment, the primary apparatus causes sending of the interface style mimicry directive, and the companion apparatus receives the interface style mimicry directive. Causation of sending may relate to sending the interface style mimicry directive directly to the companion apparatus, sending the interface style mimicry directive to a communication network that is configured to deliver the companion apparatus, and/or the like. For example, in relation to FIG. 2A, apparatus 201 may relate to a primary apparatus and apparatus 202 may relate to a companion apparatus. In such an example, the primary apparatus may cause sending of the interface style mimicry directive by sending the interface style mimicry directive by way of communication channel 211, communication channel 212, and/or the like. Consequently, the companion apparatus may receive the interface style mimicry directive by way of communication channel 211, communication channel 213, and/or the like.

In some circumstances, there may be a companionship facilitation server. In at least one example embodiment, a companionship facilitation server relates to an apparatus, which is separate from the companion apparatuses, that provides information to one or more companion apparatuses, that assists in exchange of information between companion apparatuses, that receives information from one or more companion apparatuses for the purpose of facilitating communication with another companion apparatus, and/or the like. In at least one example embodiment, the companionship facilitation server may facilitate interface style mimicry. For example, the companionship facilitation server may comprise information indicative of native interface style of one or more companion apparatuses, may comprise information associated with retrieval of an interface emulation program, and/or the like. For example, the companionship facilitation server may receive communication from a companion apparatus, and relay the communication to at least another companion apparatus. In such an example, the companionship facilitation server may store information to be sent to a companion apparatus until the companion apparatus becomes available to receive the information, until the information is sent to the companion apparatus, until the information is received by the companion apparatus, and/or the like.

For example, in relation to FIG. 2A, apparatus 201 may relate to a primary apparatus, apparatus 202 may relate to a companion apparatus, and apparatus 204 may relate to a companionship facilitation server. In such an example, the primary apparatus may send information, such as an interface style mimicry directive, to the companionship facilitation server by way of communication network 203. In such an example, the companionship facilitation server may send the interface style mimicry directive to the companion apparatus by way of communication network 203.

FIGS. 3A-3D are diagrams illustrating program icons according to at least one example embodiment. The examples of FIGS. 3A-3D are merely examples and do not limit the scope of the claims. For example, representation of the program icon may vary, number of program icons may vary, orientation may vary, and/or the like.

The examples of FIGS. 3A and 3B may relate to program icon stylistic aspects of associated with interface style. The examples of FIG. 3C may relate to different program icon stylistic aspects associated with a different interface style. The examples of FIG. 3D may relate to other different program stylistic aspects associated with another different interface style.

As previously described, at least one interactive stylistic aspect associated with an interface that may be governed by an interface style mimicry directive may relate to a program icon stylistic aspect. In at least one example embodiment, the program icon stylistic aspect relates to the manner in which a program icon is represented to the user. For example, the program icon stylistic aspect may relate to icon shape, icon color palate, icon border, and or the like.

For example, it can be seen in the example of FIG. 3A, that program icon 301 is a square with rounded corners. Furthermore, program icon 301 is represented such that program icon 301 comprises shadow representation 302. In at least one example embodiment, a program icon stylistic aspect of an interface style may govern such representational aspect of a program icon as illustrated in FIG. 3A.

In another example, FIG. 3C illustrates program icons 321, 322, and 323. It can be seen that the program icon representations of FIG. 3C are absent a predefined icon shape. For example, the shapes of program icons 321, 322, and 323 differ from each other. It can be seen that program icons 321 and 322 are shaped to conform to an image that depicts a representation of the program associated with the program icon. These program icons fail to follow a predefined program icon shape. In at least one example embodiment, a program icon stylistic aspect of an interface style may govern allowance of program icons that fail to resemble similar shapes, as illustrated in the example of FIG. 3C.

In still another example, FIG. 3D illustrates program icons 331, 332, 333, and 334. It can be seen that program icons 331, 332, 333, and 334 are rectangular program icons with right-angled corners. It can also be seen that the program icons of FIG. 3D are absent a shadow representation. In at least one example embodiment, a program icon stylistic aspect of an interface style may govern such representational aspect of a program icon as illustrated in the example of FIG. 3D.

Some operating environments allow a user to set a skin that governs appearance of an icon. In such circumstances, the operating environment may provide a setting that allows a user to designate a skin to be applied to the operating environment. In this manner, the designation of a skin for a skin setting that is provided by the operating environment may relate to a non-stylistic aspect of the operating environment. However, the availability of application of skins to the operating environment may relate to a stylistic aspect of the operating environment.

In some interface styles, size of a program icon may be varied. For example, an interface style may allow for three different sizes of an icon. In such interface style, the user may be allowed to change the size of the icon with respect to other program icons. For example, the user may be able to change the size of a designated program icon without necessarily changing the size of another program icon. In this manner, such an interface style may comprise a non-stylistic setting associated with a particular program icon that governs size of the particular program icon associated with the program. In at least one example embodiment, the program icon stylistic aspect relates to a program icon size variability aspect. A program icon size variability aspect may indicate whether an interface style allows for independent program icon size modification, number of sizes available for a program icon, one or more characteristics of the different sizes of program icons, and/or the like. In this manner, the program icon size variability aspect may relate to an aspect that governs availability of a non-stylistic setting that governs size of a particular program icon.

It can be seen in the examples of FIGS. 3B that the program icon stylistic aspect of the illustrated interface style relates to a common size for program icons. For example, it can be seen that the size and proportion of the program icons of FIG. 3B are similar to the size and proportion of program icon 311. Similarly, it can be seen in the examples of FIG. 3C that the program stylistic aspect of the illustrated interface style relate to a common size form program icons. For example, even though the shapes of program icons 321, 322, and 323 differ from each other, the size of program icons 321, 322, and 323 are similarly sized. However, it can be seen in the examples of FIG. 3D that the program stylistic aspect of the illustrated interface style relate to a variable size for program icons. For example, it can be seen that there are three consistent program icons sizes provided for by the program icon stylistic aspect of the interface style of FIG. 3D. For example, program icon 322 is smaller than program icons 333 and 334. Furthermore, even though program icons 333 and 334 are larger than program icon 332, it can be seen that program icons 333 and 334 are smaller than program icon 331. In this manner, the program icon stylistic aspect illustrated in the example of FIG. 3D may relate to a size variability aspect that allows for 3 program icon sizes. However, a designation of a particular program icon to be represented at a particular size may relate to a non-stylistic setting that governs the size of the particular program icon. For example, there may be a non-stylistic program icon setting that indicates that program icon 331 is to be sized as illustrated in the example of FIG. 3D.

In some interface styles, a program icon may provide for representation of notification associated with the program represented by the program icon. For example, a program icon associated with a messaging program may provide an indication of notification associated with received messages. In some interface styles, the notification information provided by the program icon may relate to a notification count, notification content, and/or the like. For example, the program icon may provide an indication regarding the number of notification received over a duration, such as a duration between a previous interaction with the program represented by the program icon and the current time. Such notification count may be indicative of a number of notifications associated with a program represented by the program icon. In another example, the program icon may provide, at least a portion of content associated with a notification. For example, the program icon associated with a messaging program may provide information indicative of, at least part of, content associated with a received message, such as a message title.

In at least one example embodiment, the program icon stylistic aspect relates to a program icon notification presentation aspect. The icon notification presentation aspect may relate to preclusion of a program icon from representing information indicative of a notification associated with a program represented by the program icon. For example, such preclusion may be indicative of an interface style that fails to provide for representation of notification information by way of a program icon. In at least one example embodiment, the icon notification presentation aspect relates to inclusion of a notification count by a program icon. For example, such inclusion may be indicative of an interface style that allows for representation of an indication of a notification count in relation to a program icon. In at least one example embodiment, the icon notification aspect relates to inclusion of a representation of content of a notification associated with a program represented by the program icon. For example, such inclusion may be indicative of an interface style that provides program icon representation of, at least a portion of content associated with a notification. In some circumstances, inclusion of notification count in a program icon representation may be independent of inclusion of program count in the program icon representation. For example, an interface style may provide for a program icon that indicates a notification count, absent a representation of content of a notification associated with a program represented by the program icon. In another example, the interface style may provide for a program icon that indicates a notification count, and a representation of content of a notification associated with a program represented by the program icon.

It can be seen that the example of FIG. 3B provides an example of an interface style associated with a program icon notification presentation aspect relating to inclusion of a notification count. Furthermore, it can be seen that notification count 312 of program icon 311 is represented as a circled number at the upper right corner of program icon 311. In this manner, the program icon notification presentation aspect may relate to the manner in which the notification count is represented. For example, the program icon notification presentation aspect may indicate that the notification count be represented as a circled number in the upper right corner of the associated program icon.

It can be seen that there are no notifications provided in relation to the program icons of FIG. 3C. In such an interface style, the program notification presentation aspect may relate to preclusion of a program icon from representing notification information.

It can be seen in the example of FIG. 3D that program icon 337 provides an indication of a notification count. For example, program icon 337 provides notification count representation 337. It can be seen that the representation of notification count 337 relates to a numerical representation adjacent to a program representative image contained by the program icon. It can be seen that program icon 332 provides the notification count absent any representation of notification content. In this manner, the program icon notification presentation aspect may relate to the manner in which the notification count is represented. It can be seen that program icons 331 and 334 fail to include a representation of a notification count, but may provide a representation of notification content. For example, program icon 333 comprises an image that may be indicative of notification content indicative of the basketball image provided by program icon 333. Similarly, program icon 334 comprises a plurality of images that may relate to notification content associated with the plurality of images. For example, the images may relate to images associated with contacts in an address book. It can be seen that program icon 331 comprises notification count 335 and a representation of notification content 336. It can be seen that notification count 335 indicates a number of received messages, and that notification content 336 relates to a portion of a message. In the example of FIG. 3D, it can be seen that a program icon size variability aspect may be interrelated with a program icon notification presentation aspect. For example, it can be seen that the program icon notification presentation aspect varies across program icons of different sizes. In at least one example embodiment, such interdependency of stylistic aspects may be a stylistic aspect. For example, the interface style of FIG. 3D may comprise a stylistic aspect that governs varying program icon notification presentation aspect across different program icon sizes.

FIGS. 4A-4D are diagrams illustrating parts of animations according to at least one example embodiment. The examples of FIGS. 4A-4D are merely examples and do not limit the scope of the claims. For example, a screen transitioned to may vary, a screen transitioned from may vary, a style of animation may vary, and/or the like.

The examples of FIGS. 4A-4D may relate to animation stylistic aspects associated with one or more interface styles. As previously described, at least one interactive stylistic aspect of an interface that may be governed by an interface style mimicry directive may relate to an animation stylistic aspect.

In at least one example embodiment, an animation stylistic aspect governs one or more animations associated with one or more events in the operating environment. For example, the animation stylistic aspect may govern a scroll animation, a program open animation, a program close animation, a screen transition animation, and/or the like. In at least one example embodiment, a scroll animation aspect may relate to animation associated with starting a scrolling operation, continuing a scrolling operation, terminating a scrolling operation, and/or the like. For example, the scroll animation aspect may relate to simulated inertia, lack of simulated inertia, simulated bouncing at the end of a scrollable screen, simulated resistance at an end of a scrollable screen, and/or the like. For example, the animation stylistic aspect may governs presence of a bounce animation to signify a scroll endpoint. In at least one example embodiment, an animation stylistic aspect may govern which animations are applied to various events. For example, the animation stylistic aspect may indicate that the interface style provides for varying specified animations for varying specified events. In such an example, the animation stylistic aspect may indicate an animation stylistic aspect of a first type of animation regarding a program open event, and a second type of animation regarding a transition from a program screen to a different program screen.

FIG. 4A is a diagram illustrating part of an animation according to at least one example embodiment. The animation of FIG. 4A may relate to a transition between a program screen and an idle screen. In at least one example embodiment, an idle screen relates to a screen from which a user may view program icons, for example, to launch a program. In at least one example embodiment, a program screen relates to a screen that provides for interaction with the program. For example, the program screen may comprise interface elements of the program associated with the program screen. In the example of FIG. 4A, it can be seen that the program screen is towards the left of the display and the idle screen is towards the right of the display. It can be seen that the animation is indicative of the program screen and the idle screen being disposed on orthogonal sides of a block. In this manner, the animation may exemplify a metaphor that allows the user to perceive the functional distinction between the program screen and the idle screen.

FIG. 4B is a diagram illustrating part of an animation according to at least one example embodiment. The example of FIG. 4B relates to an animation that may be associated with a transition from a program screen to a different program screen. For example, the program screen may be associated with a program and the different program screen may be associated with a different program. It can be seen that the animation of the example of FIG. 4B is indicative of a program screen being flipped to the side, like a card, and the different program screen being slid from the side, like a drawer. In this manner, the animation may apply different type of animation to different screens to signify differences between the screens.

FIG. 4C is a diagram illustrating part of an animation according to at least one example embodiment. The example of FIG. 4C relates to either a transition to an idle screen or a transition away from the idle screen. It can be seen that the animation relates to program icons being brought onto the display and arranged in accordance with an idle layout aspect, or relates to program icons being removed from the display. In this manner, the construction of the idle screen may signify a change in the displayed screen to the idle screen, or destruction of the idle screen may signify a change in the displayed screen to a screen other than the idle screen.

FIG. 4D is a diagram illustrating part of an animation according to at least one example embodiment. The example of FIG. 4D relates to either a transition to a program screen or a transition away from the program screen. It can be seen that the animation relates to the program screen being folded to align with the display, or relates to the program screen being folded to become unaligned with the display. In this manner, the folding to align the program screen may signify a change in the displayed screen to the program screen, or folding to unalign the program screen may signify a change in the displayed screen to a screen other than the program screen.

FIGS. 5A-5B are diagrams illustrating radio button representations according to at least one example embodiment. The examples of FIGS. 5A-5B are merely examples and do not limit the scope of the claims. For example, number of radio buttons may vary, orientation may vary, position may vary, and/or the like.

The examples of FIGS. 5A-5B may relate to radio button representation aspects associated with one or more interface styles. As previously described, at least one interactive stylistic aspect of an interface that may be governed by an interface style mimicry directive may relate to a radio button representation aspect. In at least one example embodiment, a radio button representation aspect relates to an interface element that provides for selection of one of a set of enumerated options. For example, the radio button representation aspect may govern the manner in which radio buttons are represented, the manner in which radio buttons a selected, and/or the like.

In at least one example embodiment, the radio button representation aspect relates to a selectable button representation. For example, the radio button representation may indicate a depressed button to identify a selected button and indicate a non-depressed button to identify a non-selected button. In some circumstances, the buttons associated with the enumerated values of the radio buttons may be spatially arranged such that the special arrangement indicates the single selection interrelationship of the radio buttons. For example, the radio buttons may be represented as parts of a single button. FIG. 5A is a diagram illustrating a selectable button representation of a radio button according to at least one example embodiment. It can be seen that radio button representations 501 502, and 503 are enumerated radio buttons associated with the same setting, such as an email protocol selection. It can be seen that radio button representations 501, 502, and 503 are spatially arranged, and shaped in a manner that resembles a single button having parts that are allocated to radio button representations 501, 502, and 503.

In at least one example embodiment, the radio button representation aspect relates to a selectable enclosure representation. For example, the selectable enclosure representation may relate to a selectable box, a selectable circle, and/or the like. For example, the selectable enclosure representation may indicate selection by way of in indicator being represented, at least partially, within the selectable enclosure representation. For example, a selectable circle enclosure may indicate selection by way of representing a filled circle within the selectable circle. FIG. 5B is a diagram illustrating a selectable enclosure representation of a radio button according to at least one example embodiment. It can be seen that radio button representations 511 512, and 513 are enumerated radio buttons associated with the same setting, such as options associated with a setting. It can be seen that radio button representations 511, 512, and 513 are spatially arranged in a commonly indented manner that resembles a common heading indention of radio button representations 511, 512, and 513.

FIGS. 6A-6C are diagrams illustrating binary selection according to at least one example embodiment. The examples of FIGS. 6A-6C are merely examples and do not limit the scope of the claims. For example, orientation may vary, position may vary, values represented by the binary selection may vary, and/or the like.

The examples of FIGS. 6A-6C may relate to binary selection aspects associated with one or more interface styles. As previously described, at least one interactive stylistic aspect of an interface that may be governed by an interface style mimicry directive may relate to a binary selection aspect. In at least one example embodiment, the binary selection aspect relates to an interface element that provides for selection of one of two enumerated options. For example, the binary selection aspect may govern selection of an on/off value of a setting, a true/false value of a setting, an enable/disable value of a setting, a restrict/allow value of a setting, and/or the like. In at least one example embodiment, the binary selection aspect relates to a slider interface element. For example, the slider interface element may indicate a value at an end of the slider interface element and may indicate a different value at the opposite end of the slider interface element. In at least one example embodiment, the binary selection aspect relates to a selectable toggle button representation. For example, the selectable toggle button representation may indicate a value by an asserted toggle of the button and may indicate a different value by a non-asserted toggle button.

FIG. 6A is a diagram illustrating binary selection according to at least one example embodiment. It can be seen that the binary selection aspect illustrated in the example of FIG. 6A relates to a slider interface element binary selection. Slider interface elements 601 and 602 relate to binary selection. For example, slider interface elements 601 and 602 illustrate selectable values of either on or off. It can be seen that the slider interface element represents the selected value by way of a textual indication of the value and shading indicative of the value. For example, a value of on is indicated by a dark shaded slider interface element, and a value of off is indicated by a dark shaded slider interface element.

FIG. 6B is a diagram illustrating binary selection according to at least one example embodiment. It can be seen that the binary selection aspect illustrated in the example of

FIG. 6B relates to a slider interface element binary selection. Slider interface elements 621 and 622 relate to binary selection. For example, slider interface elements 621 and 622 illustrate selectable values of either on or off. It can be seen that the slider interface element represents the selected value by way of shading indicative of the value and an adjacent a textual indication of the value. For example, a value of on is indicated by a dark shaded slider interface element, and a value of off is indicated by a dark shaded slider interface element.

FIG. 6C is a diagram illustrating binary selection according to at least one example embodiment. It can be seen that the binary selection aspect illustrated in the example of FIG. 6C relates to a selectable toggle button representation binary selection. Selectable toggle button interface elements 641 and 642 relate to binary selection. For example, selectable toggle button interface elements 641 and 642 illustrate selectable values of either on or off. It can be seen that the selectable toggle button interface element represents the selected value by way of a textual indication of the value absent shading indicative of the value. For example, a value of on or off is indicated by text overlying the selectable button interface element, and shading of the selectable button interface element remains similar regardless of a selection of on or off.

FIGS. 7A-7C are diagrams illustrating numeric selection according to at least one example embodiment. The examples of FIGS. 7A-7C are merely examples and do not limit the scope of the claims. For example, position may vary, orientation may vary, type of numbers may vary, and/or the like.

The examples of FIGS. 7A-7C may relate to numeric selection aspects associated with one or more interface styles. As previously described, at least one interactive stylistic aspect of an interface that may be governed by an interface style mimicry directive may relate to a numeric selection aspect. In at least one example embodiment, the numeric selection aspect relates to an interface element that provides for selection of a numerical value.

In at least one example embodiment, the numeric selection aspect relates to a slider interface element. For example, a selection position of the slider interface element may identify a numerical value. FIG. 7A is a diagram illustrating numeric selection according to at least one example embodiment. In the example of FIG. 7A, slider interface element 701 comprises the slider interface element and a textual representation 702 of the value identified by the position of the slider interface element. In the example of FIG. 7A, it can be seen that the selection position of slider interface element 701 is towards the left end of slider interface element 701, such that the selection position identifies a numerical value of 0.9, as indicated by textual representation 702.

FIG. 7B is a diagram illustrating numeric selection according to at least one example embodiment. It can be seen that the numerical value of the minute component of the time is selected by way of a scrollable set of selectable numeric enumerations such that the numeric enumeration that aligns with the hour representation identifies the selection of the numeric enumeration. It can be seen that the representation of numeric enumeration 721 identifies the selected numeric enumeration. Even though the numeric values of the numeric enumeration of the example of FIG. 7B relate to sequential numeric values, the difference between numeric enumerations may vary. For example, the numeric enumerations may relate to numerical values that differ by a different increment than one, that vary by a non-uniform amount, and/or the like.

In at least one example embodiment, the numeric selection aspect relates to a text entry interface element. A text entry interface element may relate to an edit region of a screen that may be populated by way of a keypad, a virtual keypad, and/or the like. FIG. 7C is a diagram illustrating numeric selection according to at least one example embodiment. In the example of FIG. 7C, the text entry interface element relates to edit region 741 and the virtual keypad illustrated at the bottom of the screen. In this manner, selection of one or more of the keys of the virtual keypad may cause entry of a digit of numeric value indicated by edit region 741.

FIGS. 8A-8B are diagrams illustrating navigation according to at least one example embodiment. The examples of FIGS. 8A-8B are merely examples and do not limit the scope of the claims. For example, content may vary, screens may vary, orientation may vary, and/or the like.

The examples of FIGS. 8A-8B may relate to navigation stylistic aspects associated with one or more interface styles. As previously described, at least one interactive stylistic aspect of an interface that may be governed by an interface style mimicry directive may relate to a navigation stylistic aspect. In at least one example embodiment, the navigation stylistic aspect relates to a manner in which transition from a screen to a different screen is provided for. For example, the navigation stylistic aspect may govern the type of input associated with navigation from a screen to a different screen, may govern interrelationship between screens, and/or the like.

In at least one example embodiment, the navigation stylistic aspect relates to a tabbed navigation aspect. For example, the tabbed navigation aspect may relate to provision of a plurality of selectable tabs that govern a screen to be provided in response to selection of a selectable tab. For example, the user may perform selection of a tab to cause a transition to a screen associated with the selected tab.

FIG. 8A is a diagram illustrating navigation according to at least one example embodiment. The example of FIG. 8A relates to a tabbed navigation aspect. It can be seen that the interface illustrated in the example of FIG. 8A comprises selectable tabs 801, 802, 803, and 804. It can be seen that selectable tab 801 indicates current selection so that the screen of the example of 8A is associated with selectable tab 801. In the example of FIG. 8A, a user may perform selection of selectable tab 804 to cause a transition from the screen associated with selectable tab 801 to the screen associated with selectable tab 804. In this manner, the user may perform navigation by way of selecting various selectable tabs.

In at least one example embodiment, the navigation stylistic aspect relates to a virtual screen adjacency navigation aspect. For example, the virtual screen adjacency navigation aspect may relate to provision of virtual screens such that panning beyond a boundary of a virtual screen causes transition to a different virtual screen. For example, the user may be able to navigate between screens by panning the virtual screen beyond a boundary of the virtual screen such that the display a different virtual screen is provided on the display.

FIG. 8B is a diagram illustrating navigation according to at least one example embodiment. The example of FIG. 8B relates to a virtual screen adjacency navigation aspect. It can be seen that the user may navigate from currently displayed virtual screen 821 to virtual screen 822 or virtual screen 823. It can be seen that, the height of virtual screens 821, 822, and 823 correspond with the height of the display. However, in some embodiment, the height of the virtual screens may fail to correspond with the height of the display, fail to correspond with the height of each other, and/or the like. It can be seen that the width of virtual screens 821 and 823 is slightly less than the width of the display. In this manner, the left portion of virtual screen may be seen on the display. It can be seen that the width of virtual screen 822 is greater than the width of the display. A user may pan within virtual screen 822 without crossing a boundary of virtual screen 822. In the example of FIG. 8B, a user may transition from virtual screen 821 to virtual screen 822 by panning beyond the left boundary of virtual screen 821. Similarly, a user may transition from virtual screen 821 to virtual screen 823 by panning beyond the right boundary of virtual screen 821.

FIGS. 9A-9B are diagrams illustrating idle layout according to at least one example embodiment. The examples of FIGS. 9A-9B are merely examples and do not limit the scope of the claims. For example, orientation may vary, content may vary, number of program icons may vary, and/or the like.

The examples of FIGS. 9A-9B may relate to idle layout stylistic aspects associated with one or more interface styles. As previously described, at least one interactive stylistic aspect of an interface that may be governed by an interface style mimicry directive may relate to an idle layout aspect. For example, the idle layout aspect may relate to a manner in which program icons are arranged in an idle screen. However a non-stylistic setting may govern a particular position of a particular program icon within the arrangement of the idle screen.

In at least one example embodiment, the idle layout aspect relates to a tiled icon layout. A tiled icon layout may relate to a layout of program icons that allows for variable sizes of icons such that the variable sized icons may be arranged in a manner that allows for row alignment and/or column alignment in some regions of the screen and non-alignment in other regions of the screen. The example of FIG. 3D illustrates an example of a tiled icon layout. It can be seen that program icon 331 spans a width that corresponds with the span of the four small icons below program icon 331. In this manner, program icon 331 and the small program icons below program icon 331 align along subsequent rows. It can be seen that the right edge of program icon 331 aligns with the right edge of program icon 332, and that the left edge of program icon fails to align with program icon 331. In this manner, the left edge of program icons 331 and 332 are unaligned and the right edges of program icons 331 and 332 are aligned.

In at least one example embodiment, the idle layout aspect relates to an icon grid layout. For example, an icon grid layout may relate to a layout in which program icons are arranged to align along designated rows and/or columns. In at least one example embodiment, the idle layout aspect governs at least one of, number of rows associated with the icon grid layout, or number of columns associated with the icon grid layout. The example of FIG. 9A illustrates an icon grid layout stylistic aspect associated with a variable number of rows and a single column. The example of FIG. 9B illustrates an icon grid layout stylistic aspect associated with five rows and four columns.

FIGS. 10A-10C are diagrams illustrating lock screens according to at least one example embodiment. The examples of FIGS. 10A-10C are merely examples and do not limit the scope of the claims. For example, content may vary, orientation may vary, presentation configuration may vary, and/or the like.

The examples of FIGS. 10A-10C may relate to animation stylistic aspects associated with one or more interface styles. As previously described, at least one interactive stylistic aspect of an interface that may be governed by an interface style mimicry directive may relate to a lock screen aspect. For example, the lock screen aspect may relate to representation of information in a lock screen. In at least one example embodiment, a lock screen relates to a screen that is provided after a lock event. For example, a lock screen may be provided when a user locks the apparatus, when a threshold duration has elapsed absent input for a user, and/or the like.

In at least one example embodiment, the lock screen aspect relates to representation of notification information associated with an enumerated set of programs. For example, the lock screen aspect may allow for a non-stylistic setting that identifies particular programs for which to represent notification information within the lock screen. For example, the lock screen aspect may relate to a lock screen program notification presentation aspect associated with a program. In such an example, the lock screen program notification presentation aspect may relate to preclusion of a program icon from representing information indicative of a notification associated with the program, may relate to inclusion of a notification count, may relate a notification count absent a representation of content of a notification associated with the program, may relate to inclusion of a representation of content of a notification associated with the program, and/or the like.

FIG. 10A is a diagram illustrating a lock screen according to at least one example embodiment. It can be seen that the lock screen of FIG. 10A comprises an apparatus status indication portion 1001 that represents information such as wireless signal strength, communication channel type, batter power level, and/or the like. It can be seen that the lock screen aspect of the example of FIG. 10A allows for a designated lock screen wallpaper 1002. In at least one example embodiment, there may be a non-stylistic setting that identifies an image to be utilized as the wallpaper. It can be seen that time indicator 1003 provides a representation of the current time. It can be seen that notification 1004 provides for content of the notification, particularly calendar information associated with an upcoming event. It can be seen that the lock screen aspect of FIG. 10A provides for designated positions for program notification representations. For example, it can be seen that notification representations 1005, 1006, 1007, and 1008 are positioned in accordance with a designated order. In at least one example embodiment, the lock screen aspect may provide for availability of designation of the ordering of notification associated with particular programs. However, a non-stylistic setting may identify which programs are in the particular order.

FIG. 10B is a diagram illustrating a lock screen according to at least one example embodiment. It can be seen that the lock screen of FIG. 10B comprises an apparatus status indication portion 1021 that represents information such as wireless signal strength, communication channel type, universal serial bus availability, batter power level, time, and/or the like. It can be seen that the lock screen aspect of the example of FIG. 10B allows for a designated lock screen wallpaper 1022. In at least one example embodiment, there may be a non-stylistic setting that identifies an image to be utilized as the wallpaper. It can be seen that time indicator 1023 provides a representation of the current time along with another representation of battery power level. It can be seen that the lock screen aspect of FIG. 10B precludes representation of notifications. In the example of FIG. 10B, the lock screen aspect provides for an unlock input element 1029 and a volume adjustment element 1030.

FIG. 10C is a diagram illustrating a lock screen according to at least one example embodiment. It can be seen that the lock screen of FIG. 10C comprises an apparatus status indication portion 1041 that represents information such as wireless signal strength, wireless operator identity, batter power level, and/or the like. It can be seen that the lock screen aspect of the example of FIG. 10C allows for a designated lock screen wallpaper 1042. In at least one example embodiment, there may be a non-stylistic setting that identifies an image to be utilized as the wallpaper. It can be seen that time indicator 1043 provides a representation of the current time. It can be seen that notification 1044 provides for content of the notification, particularly current weather information. It can be seen that the lock screen aspect of FIG. 10C provides for a sequential listing of program notification representations. For example, notification representations 1045 and 1046 may be positioned in a sequential order. In the example of FIG. 10C, the lock screen aspect provides for an unlock input element 1049.

It should be understood that the stylistic aspects discussed herein are merely examples of stylistic aspects that may be present in an interface style. Furthermore, it should be understood that the examples of stylistic aspects described herein are not intended to be an exhaustive list of all possible stylistic aspects and/or permutations of stylistic aspects. For example, in at least one example embodiment, the interactive stylistic aspect relates to a gesture aspect. The gesture aspect may relate to an association between a predetermined gesture and an operation. For example, a gesture aspect may identify a four touch sliding input with invocation of a list of running programs. In such an example, the association, the gesture, and the operation may conform to a native interface style of an operating environment.

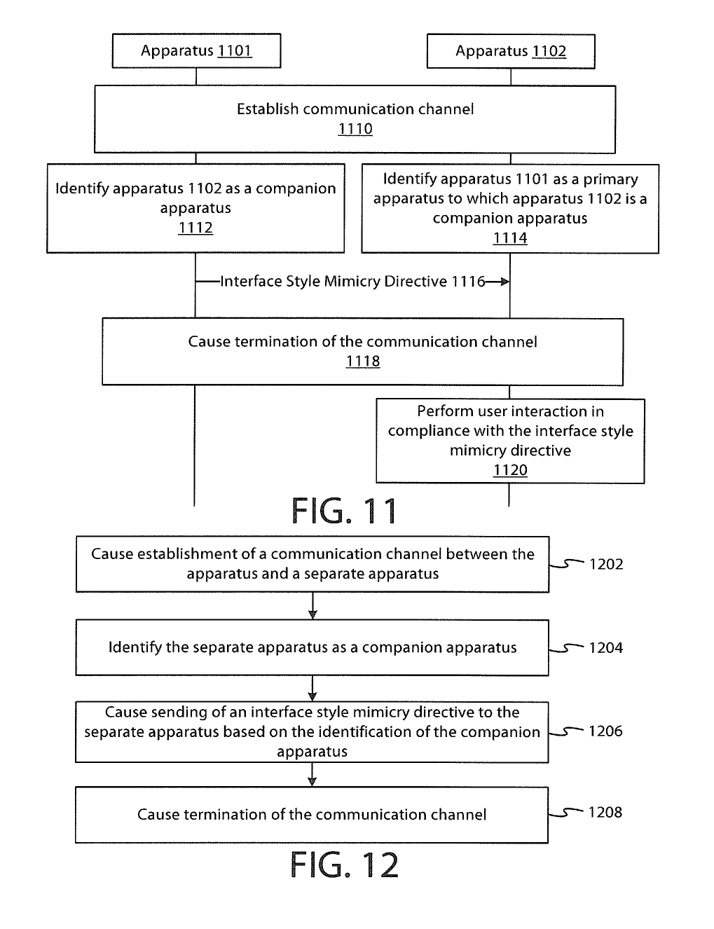

FIG. 11 is an interaction diagram showing activities associated with interface style mimicry according to at least one example embodiment. In at least one example embodiment, there is a set of operations that corresponds with, at least some of, the activities of FIG. 11. For example, there may be a set of operations associated with activities of one or more apparatuses of FIG. 11. An apparatus, for example a primary apparatus or a companion apparatus, or a portion thereof, may utilize the set of operations. The apparatus may comprise means, including, for example processor 11 of FIG. 1, for performance of such operations. In an example embodiment, an apparatus is transformed by having memory, for example memory 12 of FIG. 1, comprising computer code configured to, working with a processor, for example processor 11 of FIG. 1, cause the apparatus to perform set of operations of FIG. 11.

In the example of FIG. 11, apparatus 1101 may relate to a primary apparatus and apparatus 1102 may relate to a companion apparatus. At block 1110, apparatus 1101 and apparatus 1102 cause establishment of a communication channel with each other. The establishment and the communication channel may be similar as described regarding FIGS. 2A-2B.

At block 1112, apparatus 1101 identifies apparatus 1102 as a companion apparatus. The identification may be similar as described regarding FIGS. 2A-2B.

At block 1114, apparatus 1102 identifies apparatus 1101 as a primary apparatus to which apparatus 1102 is a companion apparatus. The identification may be similar as described regarding FIGS. 2A-2B.

At interaction 1116, apparatus 1101 causes sending of an interface style mimicry directive to apparatus 1102 based, at least in part, on the identification of the companion apparatus. The sending and the interface style mimicry directive may be similar as described regarding FIGS. 2A-2B, FIGS. 3A-3D, FIGS. 4A-4D, FIGS. 5A-5B, FIGS. 6A-6C, FIGS. 7A-7C, FIGS. 8A-8B, FIGS. 9A-9B, and FIGS. 10A-10C. In at least one example embodiment, the sending of the interface style mimicry directive is predicated by the identification of the companion apparatus. Consequently, apparatus 1102 receives the interface style mimicry directive. In at least one example embodiment, receipt of the interface style mimicry directive is predicated by the identification of the companion apparatus. For example, in circumstances where an apparatus receives an interface style mimicry directive from an apparatus that is unidentified as a primary apparatus, the apparatus may fail to recognize the interface style mimicry directive as an actual interface style mimicry directive.

At block 1118, apparatus 1101 and apparatus 1102 cause termination of the communication channel. The termination may be similar as described regarding FIGS. 2A-2B.

At block 1120, apparatus 1102 performs user interaction in compliance with the interface style mimicry directive. The performance of the user interaction may be similar as described regarding FIGS. 2A-2B, FIGS. 3A-3D, FIGS. 4A-4D, FIGS. 5A-5B, FIGS. 6A-6C, FIGS. 7A-7C, FIGS. 8A-8B, FIGS. 9A-9B, and FIGS. 10A-10C. In this manner, apparatus 1102 may perform the user interaction in compliance with the interface style mimicry directive absent concurrent communication with apparatus 1101.

FIG. 12 is a flow diagram illustrating activities associated with causation of stylistic mimicry on a companion apparatus according to at least one example embodiment. In at least one example embodiment, there is a set of operations that corresponds the activities of FIG. 12. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 12. In at least one example embodiment, the apparatus of FIG. 12 relates to a primary apparatus.

At block 1202, the apparatus causes establishment of a communication channel between the apparatus and a separate apparatus. The establishment and the communication channel may be similar as described regarding FIGS. 2A-2B.

At block 1204, the apparatus identifies the separate apparatus as a companion apparatus. The identification may be similar as described regarding FIGS. 2A-2B.

At block 1206, the apparatus causes sending of an interface style mimicry directive to the separate apparatus based, at least in part, on the identification of the companion apparatus. The sending and the interface style mimicry directive may be similar as described regarding FIGS. 2A-2B, FIGS. 3A-3D, FIGS. 4A-4D, FIGS. 5A-5B, FIGS. 6A-6C, FIGS. 7A-7C, FIGS. 8A-8B, FIGS. 9A-9B, and FIGS. 10A-10C. In at least one example embodiment, the sending of the interface style mimicry directive is predicated by the identification of the companion apparatus.

At block 1208, the apparatus causes termination of the communication channel. The termination may be similar as described regarding FIGS. 2A-2B.

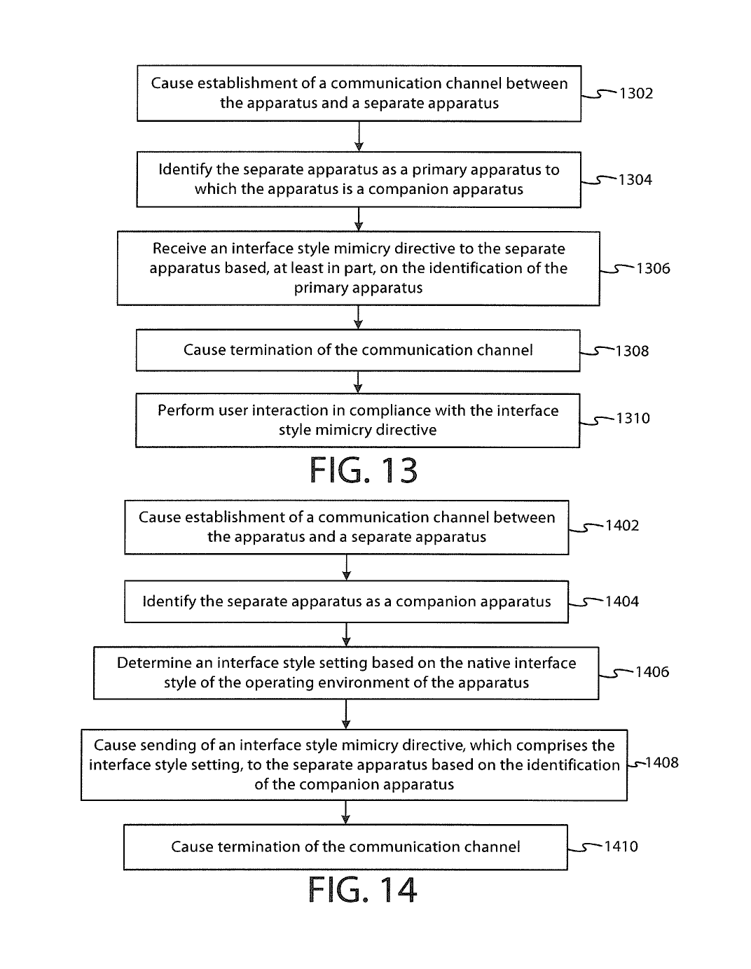

FIG. 13 is a flow diagram illustrating activities associated with causation of stylistic mimicry on a companion apparatus according to at least one example embodiment. In at least one example embodiment, there is a set of operations that corresponds the activities of FIG. 13. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 13. In at least one example embodiment, the apparatus of FIG. 13 relates to a companion apparatus.

At block 1302, the apparatus causes establishment of a communication channel between the apparatus and a separate apparatus. The establishment and the communication channel may be similar as described regarding FIGS. 2A-2B.

At block 1304, the apparatus identifies the separate apparatus as a primary apparatus to which the apparatus is a companion apparatus. The identification may be similar as described regarding FIGS. 2A-2B.

At block 1306, the apparatus receives an interface style mimicry directive based, at least in part, on the identification of the primary apparatus. The receipt and the interface style mimicry directive may be similar as described regarding FIGS. 2A-2B, FIGS. 3A-3D, FIGS. 4A-4D, FIGS. 5A-5B, FIGS. 6A-6C, FIGS. 7A-7C, FIGS. 8A-8B, FIGS. 9A-9B, and FIGS. 10A-10C. In at least one example embodiment, the sending of the interface style mimicry directive is predicated by the identification of the companion apparatus.

At block 1308, the apparatus causes termination of the communication channel. The termination may be similar as described regarding FIGS. 2A-2B.

At block 1310, the apparatus performs user interaction in compliance with the interface style mimicry directive. The performance of the user interaction may be similar as described regarding FIGS. 2A-2B, FIGS. 3A-3D, FIGS. 4A-4D, FIGS. 5A-5B, FIGS. 6A-6C, FIGS. 7A-7C, FIGS. 8A-8B, FIGS. 9A-9B, and FIGS. 10A-10C. In this manner, the apparatus may perform the user interaction in compliance with the interface style mimicry directive absent concurrent communication with the separate apparatus.

FIG. 14 is a flow diagram illustrating activities associated with causation of stylistic mimicry on a companion apparatus according to at least one example embodiment. In at least one example embodiment, there is a set of operations that corresponds the activities of FIG. 14. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 14. In at least one example embodiment, the apparatus of FIG. 14 relates to a primary apparatus.

As previously described, the primary apparatus may determine the interface style mimicry directive. In at least one example embodiment, the primary apparatus determines at least one interface style setting based, at least in part, on the native interface style of the operating environment of the apparatus. In such an example, the interface style mimicry directive may comprise information indicative of the interface style setting. In at least one example embodiment, the interface style setting relates to a setting that configures a stylistic aspect of the native interface of the separate apparatus. In at least one example embodiment, the interface style relates to a setting that is unavailable for user modification by way of the native interface of the separate apparatus.

At block 1402, the apparatus causes establishment of a communication channel between the apparatus and a separate apparatus, similarly as described regarding block 1202 of FIG. 12. At block 1404, the apparatus identifies the separate apparatus as a companion apparatus, similarly as described regarding block 1204 of FIG. 12.

At block 1406, the apparatus determines of at least one interface style setting based, at least in part, on the native interface style of the operating environment of the apparatus.

At block 1408, the apparatus causes sending of an interface style mimicry directive, which comprises information indicative of the interface style setting, to the separate apparatus based, at least in part, on the identification of the companion apparatus. The sending and the interface style mimicry directive may be similar as described regarding FIGS. 2A-2B, FIGS. 3A-3D, FIGS. 4A-4D, FIGS. 5A-5B, FIGS. 6A-6C, FIGS. 7A-7C, FIGS. 8A-8B, FIGS. 9A-9B, and FIGS. 10A-10C. In at least one example embodiment, the sending of the interface style mimicry directive is predicated by the identification of the companion apparatus.

At block 1410, the apparatus causes termination of the communication channel, similarly as described regarding block 1208 of FIG. 12.

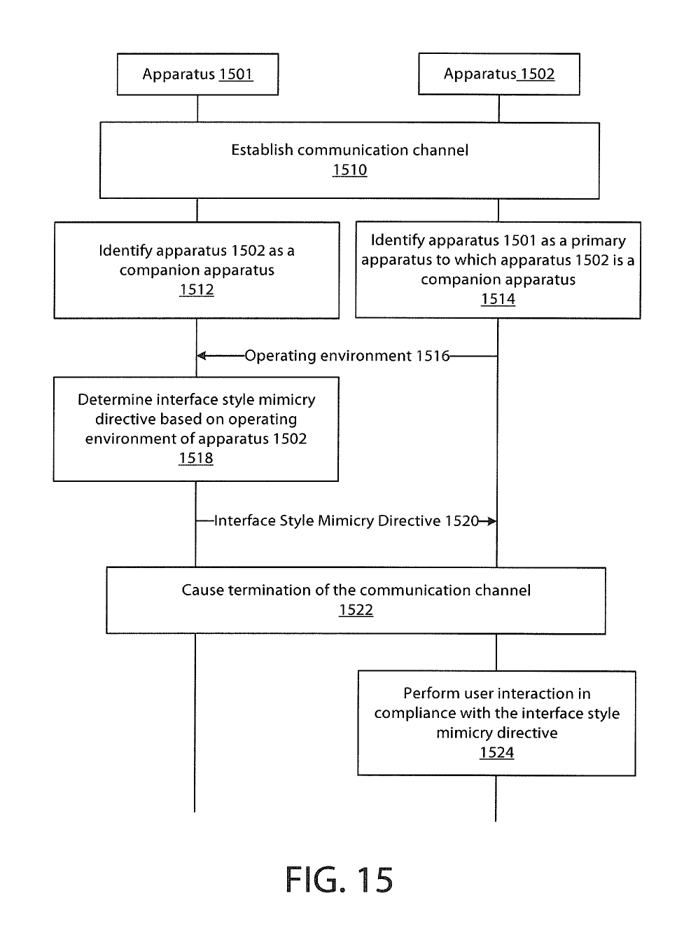

FIG. 15 is an interaction diagram showing activities associated with interface style mimicry according to at least one example embodiment. In at least one example embodiment, there is a set of operations that corresponds with, at least some of, the activities of FIG. 15. For example, there may be a set of operations associated with activities of one or more apparatuses of FIG. 15. An apparatus, for example a primary apparatus or a companion apparatus, or a portion thereof, may utilize the set of operations. The apparatus may comprise means, including, for example processor 11 of FIG. 1, for performance of such operations. In an example embodiment, an apparatus is transformed by having memory, for example memory 12 of FIG. 1, comprising computer code configured to, working with a processor, for example processor 11 of FIG. 1, cause the apparatus to perform set of operations of FIG. 15.

In some circumstances, it may be desirable to base the interface style mimicry directive on the operating environment of the companion apparatus. For example, the interface style memory directive may comprise information indicative of interface style settings that relate to differences between the native interface style of the primary apparatus and the native interface style of the companion interface. In such an example, the primary apparatus may receive information indicative of the operating environment of the companion apparatus. The primary apparatus may receive the information indicative of the operating environment of the companion apparatus from the companion apparatus, from a companionship facilitation server, and/or the like. In circumstances where the primary apparatus receives the information indicative of the operating environment of the companion apparatus from the companionship facilitation server, the companion apparatus may have previously sent information indicative of the operating environment of the companion apparatus to the companionship facilitation server.

In the example of FIG. 15, apparatus 1501 may relate to a primary apparatus and apparatus 1502 may relate to a companion apparatus. At block 1510, apparatus 1501 and apparatus 1502 cause establishment of a communication channel with each other, similarly as described regarding block 1110 of FIG. 11. At block 1512, apparatus 1501 identifies apparatus 1502 as a companion apparatus, similarly as described regarding block 1112 of FIG. 11. At block 1514, apparatus 1502 identifies apparatus 1501 as a primary apparatus to which apparatus 1502 is a companion apparatus, similarly as described regarding block 1114 of FIG. 11.

At interaction 1216, apparatus 1502 causes sending of information indicative of an operating environment of apparatus 1502. The sending and the operating environment may be similar as described regarding FIGS. 2A-2B. Consequently, at interaction 1216, apparatus 1501 receives information indicative of an operating environment of apparatus 1502.

At block 1518, apparatus 1501 determines an interface style mimicry directive is based, at least in part, on the operating environment of apparatus 1502. The determination and the interface style mimicry directive may be similar as described regarding FIGS. 2A-2B, FIGS. 3A-3D, FIGS. 4A-4D, FIGS. 5A-5B, FIGS. 6A-6C, FIGS. 7A-7C, FIGS. 8A-8B, FIGS. 9A-9B, and FIGS. 10A-10C. In at least one example embodiment, the determination of the interface style mimicry directive comprises determining information associated with modification of a native interface style of the operating environment of apparatus 1502 to be similar to the native interface style of the operating environment of apparatus 1501. Such similarity may be governed by one or more stylistic settings.

At interaction 1520, apparatus 1501 causes sending of the interface style mimicry directive to apparatus 1502 based, at least in part, on the identification of the companion apparatus, similarly as described regarding block 1116 of FIG. 11. At block 1522, apparatus 1501 and apparatus 1502 cause termination of the communication channel, similarly as described regarding block 1118 of FIG. 11. At block 1524, apparatus 1502 performs user interaction in compliance with the interface style mimicry directive, similarly as described regarding block 1120 of FIG. 11.

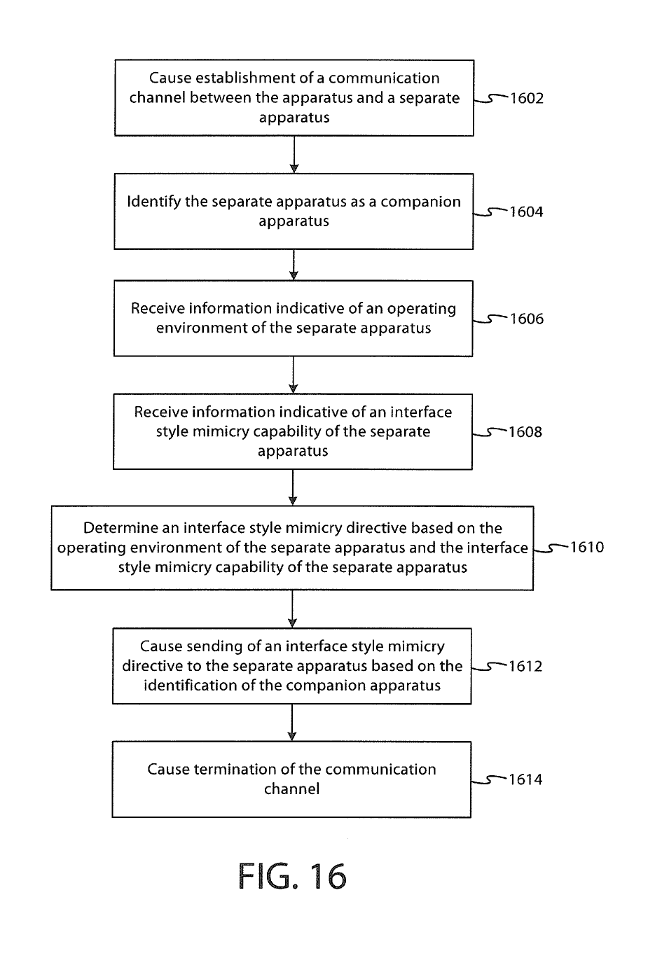

FIG. 16 is a flow diagram illustrating activities associated with causation of stylistic mimicry on a companion apparatus according to at least one example embodiment. In at least one example embodiment, there is a set of operations that corresponds the activities of FIG. 16. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 16. In at least one example embodiment, the apparatus of FIG. 16 relates to a primary apparatus.

In some circumstances, it may be desirable to base the interface style mimicry directive on the capability of the companion apparatus to mimic the native interface of the primary apparatus. For example, it may be desirable to ascertain the companion apparatus' ability to perform user interaction in conformance with the native interface style of the primary apparatus. In such an example, the primary apparatus may receive information indicative of the interface style mimicry capability of the companion apparatus. The primary apparatus may receive the information indicative of the interface style mimicry capability of the companion apparatus from the companion apparatus, from a companionship facilitation server, and/or the like. In circumstances where the primary apparatus receives the information indicative of the interface style mimicry capability of the companion apparatus from the companionship facilitation server, the companion apparatus may have previously sent information indicative of the interface style mimicry capability of the companion apparatus to the companionship facilitation server.

In some circumstances, the primary apparatus may have previously received information indicative of the interface style mimicry capability of the companion apparatus. In such circumstances, the primary apparatus may have stored the information indicative of the interface style mimicry capability of the companion apparatus. In such circumstances, the primary apparatus may retrieve, from memory, information indicative of the interface style mimicry capability of the separate apparatus. In some circumstances, the companion apparatus may store information indicative of the interface style mimicry capability of the companion apparatus. In such circumstances, the companion apparatus may retrieve, from memory, the information indicative of the interface style mimicry capability of the companion apparatus.

In at least one example embodiment, the interface style mimicry capability is based, at least in part, on availability of an interface emulation program. In at least one example embodiment, the interface emulation program relates to a program that allows the companion apparatus to emulate, at least one stylistic aspect, indicated by the interface style mimicry capability.

At block 1602, the apparatus causes establishment of a communication channel between the apparatus and a separate apparatus, similarly as described regarding block 1202 of FIG. 12. At block 1604, the apparatus identifies the separate apparatus as a companion apparatus, similarly as described regarding block 1204 of FIG. 12. At block 1606, the apparatus receives information indicative of an operating environment of apparatus, similarly as described regarding interaction 1516 of FIG. 15.

At block 1608, the apparatus receives information indicative of the interface style mimicry capability of the separate apparatus.

At block 1610, the apparatus determines the interface style mimicry directive based, at least in part, on the native interface style of the operating environment of the separate apparatus and the interface style mimicry capability of the separate apparatus.

At block 1612, the apparatus causes sending of the interface style mimicry directive to the separate apparatus based, at least in part, on the identification of the companion apparatus. The sending and the interface style mimicry directive may be similar as described regarding FIGS. 2A-2B, FIGS. 3A-3D, FIGS. 4A-4D, FIGS. 5A-5B, FIGS. 6A-6C, FIGS. 7A-7C, FIGS. 8A-8B, FIGS. 9A-9B, and FIGS. 10A-10C. In at least one example embodiment, the sending of the interface style mimicry directive is predicated by the identification of the companion apparatus.

At block 1614, the apparatus causes termination of the communication channel, similarly as described regarding block 1208 of FIG. 12.

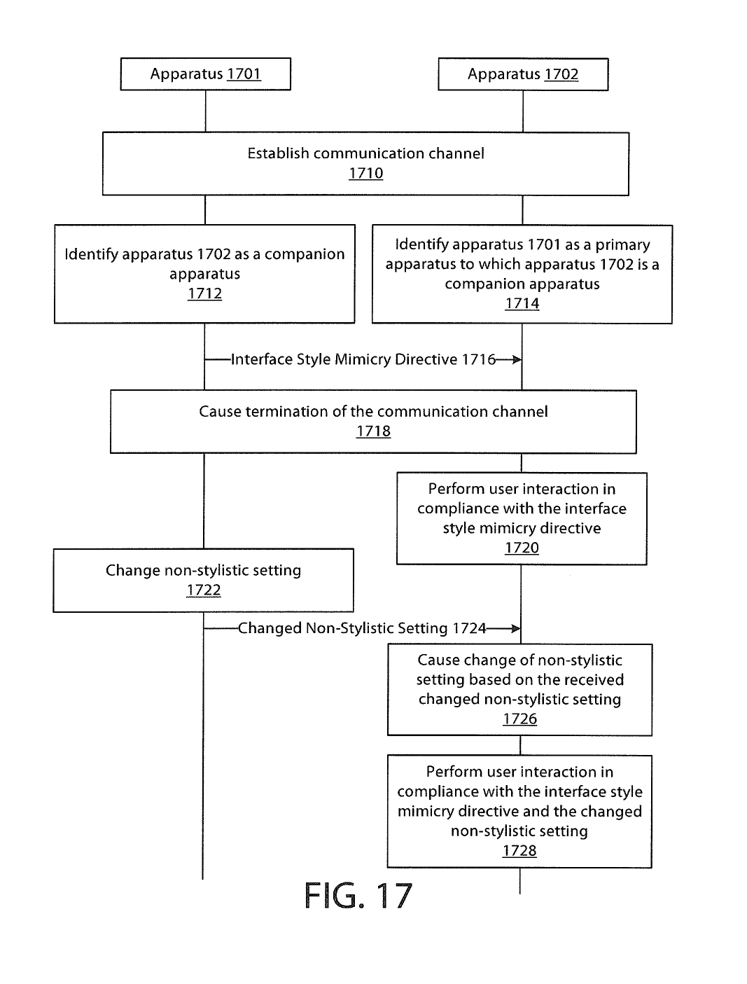

FIG. 17 is an interaction diagram showing activities associated with interface style mimicry according to at least one example embodiment. In at least one example embodiment, there is a set of operations that corresponds with, at least some of, the activities of FIG. 17. For example, there may be a set of operations associated with activities of one or more apparatuses of FIG. 17. An apparatus, for example a primary apparatus or a companion apparatus, or a portion thereof, may utilize the set of operations. The apparatus may comprise means, including, for example processor 11 of FIG. 1, for performance of such operations. In an example embodiment, an apparatus is transformed by having memory, for example memory 12 of FIG. 1, comprising computer code configured to, working with a processor, for example processor 11 of FIG. 1, cause the apparatus to perform set of operations of FIG. 17.

In some circumstances, a primary apparatus may change a non-stylistic setting. For example, the primary apparatus may change the wallpaper image, a position of an icon, an icon size, and/or the like. In such circumstances, it may be desirable for the companion apparatus to change the manner in which the companion apparatus interacts with the user so that the user may perceive a similar change when utilizing the companion apparatus. In this manner, the companion apparatus may receive information indicative of the change of the non-stylistic setting. The companion apparatus may change a corresponding non-stylistic setting to mimic the change of the non-stylistic setting of the primary apparatus.

In the example of FIG. 17, apparatus 1701 may relate to a primary apparatus and apparatus 1702 may relate to a companion apparatus. At block 1710, apparatus 1701 and apparatus 1702 cause establishment of a communication channel with each other, similarly as described regarding block 1110 of FIG. 11. At block 1712, apparatus 1701 identifies apparatus 1702 as a companion apparatus similarly as described regarding block 1112 of FIG. 11. At block 1714, apparatus 1702 identifies apparatus 1701 as a primary apparatus to which apparatus 1702 is a companion apparatus, similarly as described regarding block 1114 of FIG. 4. At interaction 1716, apparatus 1701 causes sending of an interface style mimicry directive to apparatus 1702 based, at least in part, on the identification of the companion apparatus, similarly as described regarding block 1116 of FIG. 11. At block 1718, apparatus 1701 and apparatus 1702 cause termination of the communication channel, similarly as described regarding block 1118 of FIG. 11. At block 1720, apparatus 1702 performs user interaction in compliance with the interface style mimicry directive, similarly as described regarding block 1120 of FIG. 11.

At block 1722, apparatus 1701 changes a non-stylistic setting. The non-stylistic setting may be similar as described regarding FIGS. 2A-2B.

At block 1724, apparatus 1701 causes sending of information indicative of the changed non-stylistic setting to apparatus 1702. The sending may be similar as described regarding FIGS. 2A-2B. In this manner, apparatus 1702 receives information indicative of the changed non-stylistic setting.

At block 1726, apparatus 1702 causes change of the non-stylistic setting based, at least in part, on the information indicative of the changed non-stylistic setting.

At block 1728, apparatus 1702 performs user interaction in compliance with the interface style mimicry directive and the changed non-stylistic setting. The performance of the user interaction may be similar as described regarding FIGS. 2A-2B, FIGS. 3A-3D,

FIGS. 4A-4D, FIGS. 5A-5B, FIGS. 6A-6C, FIGS. 7A-7C, FIGS. 8A-8B, FIGS. 9A-9B, and FIGS. 10A-10C. In this manner, apparatus 1102 may perform the user interaction in compliance with the interface style mimicry directive and the changed non-stylistic setting absent concurrent communication with apparatus 1101.

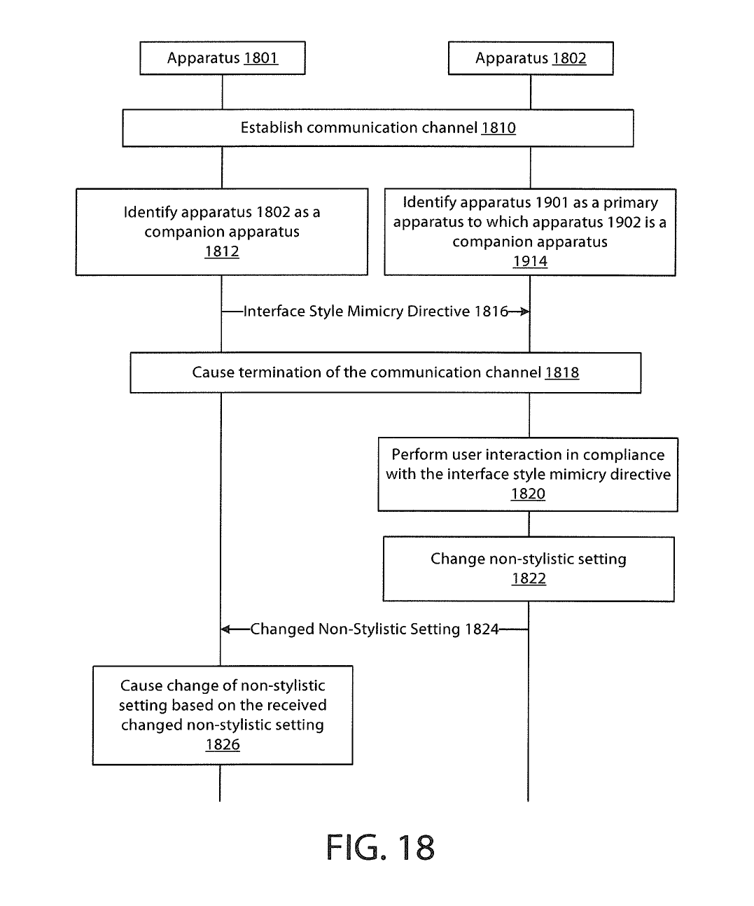

FIG. 18 is an interaction diagram showing activities associated with interface style mimicry according to at least one example embodiment. In at least one example embodiment, there is a set of operations that corresponds with, at least some of, the activities of FIG. 18. For example, there may be a set of operations associated with activities of one or more apparatuses of FIG. 18. An apparatus, for example a primary apparatus or a companion apparatus, or a portion thereof, may utilize the set of operations. The apparatus may comprise means, including, for example processor 11 of FIG. 1, for performance of such operations. In an example embodiment, an apparatus is transformed by having memory, for example memory 12 of FIG. 1, comprising computer code configured to, working with a processor, for example processor 11 of FIG. 1, cause the apparatus to perform set of operations of FIG. 18.

In some circumstances, a companion apparatus may change a non-stylistic setting. For example, the companion apparatus may change the wallpaper image, a position of an icon, an icon size, and/or the like. In such circumstances, it may be desirable for the primary apparatus to change the manner in which the primary apparatus interacts with the user so that the user may perceive a similar change when utilizing the primary apparatus. In this manner, the primary apparatus may receive information indicative of the change of the non-stylistic setting. The primary apparatus may change a corresponding non-stylistic setting to mimic the change of the non-stylistic setting of the companion apparatus.

In the example of FIG. 18, apparatus 1801 may relate to a primary apparatus and apparatus 1802 may relate to a companion apparatus. At block 1810, apparatus 1801 and apparatus 1802 cause establishment of a communication channel with each other, similarly as described regarding block 1110 of FIG. 11. At block 1812, apparatus 1801 identifies apparatus 1802 as a companion apparatus similarly as described regarding block 1112 of FIG. 11. At block 1814, apparatus 1802 identifies apparatus 1801 as a primary apparatus to which apparatus 1802 is a companion apparatus, similarly as described regarding block 1114 of FIG. 4. At interaction 1816, apparatus 1801 causes sending of an interface style mimicry directive to apparatus 1802 based, at least in part, on the identification of the companion apparatus, similarly as described regarding block 1116 of FIG. 11. At block 1818, apparatus 1801 and apparatus 1802 cause termination of the communication channel, similarly as described regarding block 1118 of FIG. 11. At block 1820, apparatus 1802 performs user interaction in compliance with the interface style mimicry directive, similarly as described regarding block 1120 of FIG. 11.

At block 1822, apparatus 1802 changes a non-stylistic setting. The non-stylistic setting may be similar as described regarding FIGS. 2A-2B.

At block 1824, apparatus 1802 causes sending of information indicative of the changed non-stylistic setting to apparatus 1801. The sending may be similar as described regarding FIGS. 2A-2B. In this manner, apparatus 1801 receives information indicative of the changed non-stylistic setting.

At block 1826, apparatus 1801 causes change of the non-stylistic setting based, at least in part, on the information indicative of the changed non-stylistic setting. In this manner, the primary apparatus may interact with the user in conformance with the changed non-stylistic setting.

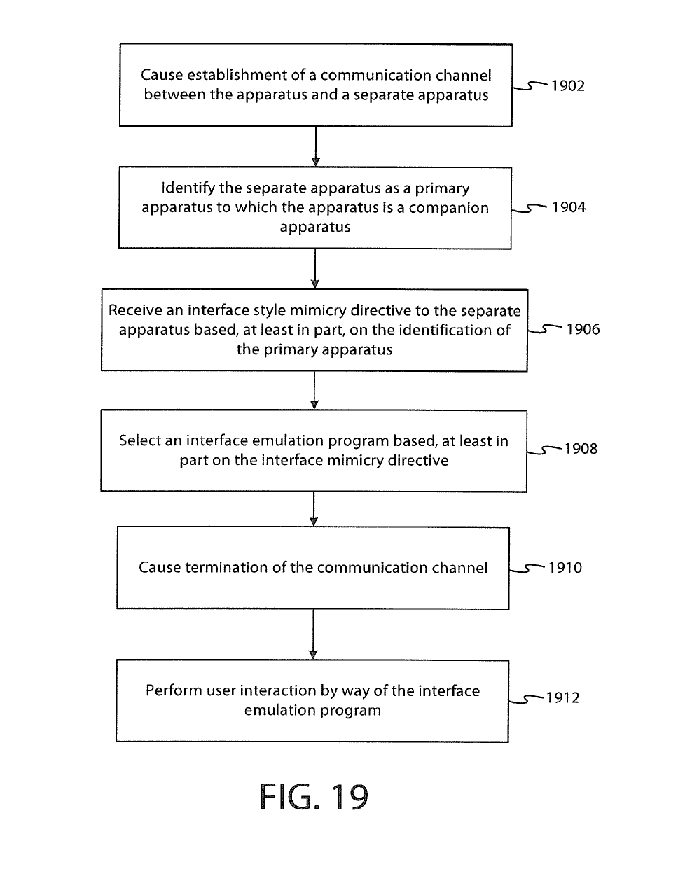

FIG. 19 is a flow diagram illustrating activities associated with causation of stylistic mimicry on a companion apparatus according to at least one example embodiment. In at least one example embodiment, there is a set of operations that corresponds the activities of FIG. 19. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 19. In at least one example embodiment, the apparatus of FIG. 19 relates to a companion apparatus.

In some circumstances, it may be desirable for the companion apparatus to take actions to reconfigure itself to perform user interaction in compliance with the interface style mimicry directive. For example, the companion apparatus may determine at least one interface style setting based, at least in part, on the native interface style of the operating environment of the apparatus and the interface style mimicry directive. For example, the companion apparatus may evaluate one or more differences of the native interface style of the primary apparatus and the native interface style of the companion apparatus. In this manner, the interface style setting may govern a stylistic aspect that differs between the native interface style of the operating environment of the companion apparatus and the interface style mimicry directive. In at least one example embodiment, the interface style mimicry directive specifies an operating system, and performance of user interaction in compliance with the interface style mimicry directive comprises determination of at least one stylistic setting associated with a native interface of the operating system.

In at least one example embodiment, performance of user interaction in compliance with the interface style mimicry directive may comprise execution of an interface emulation program that causes the apparatus to emulate, at least one stylistic aspect, indicated by the interface style mimicry directive. In at least one example embodiment, selection of the interface emulation program is based, at least in part, an enumeration of available interface emulation programs. The companion apparatus may receive information indicative of an enumeration of available interface emulation programs from which to select the interface emulation program.

At block 1902, the apparatus causes establishment of a communication channel between the apparatus and a separate apparatus, similarly as described regarding block 1302 of FIG. 13.

At block 1904, the apparatus identifies the separate apparatus as a primary apparatus to which the apparatus is a companion apparatus, similarly as described regarding block 1304 of FIG. 13.

At block 1906, the apparatus receives an interface style mimicry directive based, at least in part, on the identification of the primary apparatus, similarly as described regarding block 1306 of FIG. 13.

At block 1908, the apparatus selection an interface emulation program based, at least in part, on the interface style mimicry directive. The interface emulation program may be similar as described regarding FIGS. 2A-2B.

At block 1910, the apparatus causes termination of the communication channel, similarly as described regarding block 1308 of FIG. 13.

At block 1912, the apparatus performs user interaction by way of the interface emulation program. The performance of the user interaction may be similar as described regarding FIGS. 2A-2B, FIGS. 3A-3D, FIGS. 4A-4D, FIGS. 5A-5B, FIGS. 6A-6C, FIGS. 7A-7C, FIGS. 8A-8B, FIGS. 9A-9B, and FIGS. 10A-10C. In this manner, the apparatus may perform the user interaction in compliance with the interface style mimicry directive absent concurrent communication with the separate apparatus.

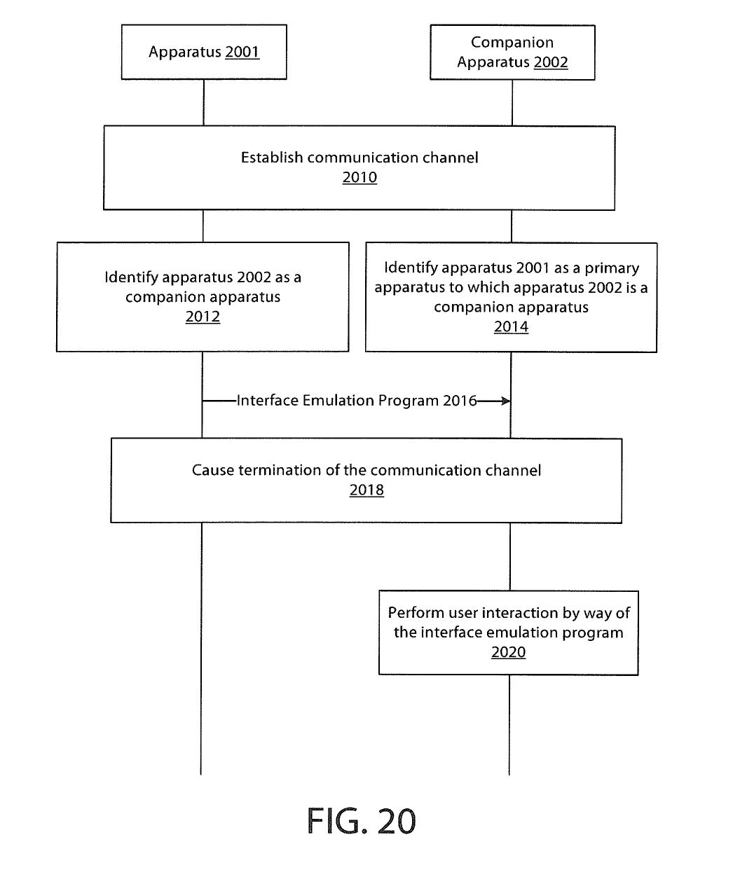

FIG. 20 is an interaction diagram showing activities associated with interface style mimicry according to at least one example embodiment. In at least one example embodiment, there is a set of operations that corresponds with, at least some of, the activities of FIG. 20. For example, there may be a set of operations associated with activities of one or more apparatuses of FIG. 20. An apparatus, for example a primary apparatus or a companion apparatus, or a portion thereof, may utilize the set of operations. The apparatus may comprise means, including, for example processor 11 of FIG. 1, for performance of such operations. In an example embodiment, an apparatus is transformed by having memory, for example memory 12 of FIG. 1, comprising computer code configured to, working with a processor, for example processor 11 of FIG. 1, cause the apparatus to perform set of operations of FIG. 20.

In some circumstances, the interface style mimicry directive comprises information associated with an interface emulation program. For example, the interface style mimicry directive may comprise an address from which the companion apparatus may obtain a suitable interface emulation program, may comprise the interface emulation program, and/or the like. In at least one example embodiment, the companion apparatus may receive an interface emulation program from a companionship facilitation server.

In the example of FIG. 20, apparatus 2001 may relate to a primary apparatus and apparatus 2002 may relate to a companion apparatus. At block 2010, apparatus 2001 and apparatus 2002 cause establishment of a communication channel with each other, similarly as described regarding block 1110 of FIG. 11. At block 2012, apparatus 2001 identifies apparatus 2002 as a companion apparatus similarly as described regarding block 1112 of FIG. 11. At block 2014, apparatus 2002 identifies apparatus 2001 as a primary apparatus to which apparatus 2002 is a companion apparatus, similarly as described regarding block 1114 of FIG. 11.

At interaction 2016, apparatus 2001 sends an interface emulation program, associated with the native interface of apparatus 2001, to apparatus 2002. At block 2018, apparatus 2001 and apparatus 2002 cause termination of the communication channel, similarly as described regarding block 1118 of FIG. 11.

At block 2020, apparatus 2002 performs user interaction by way of the interface emulation program. The performance of the user interaction may be similar as described regarding FIGS. 2A-2B, FIGS. 3A-3D, FIGS. 4A-4D, FIGS. 5A-5B, FIGS. 6A-6C, FIGS. 7A-7C, FIGS. 8A-8B, FIGS. 9A-9B, and FIGS. 10A-10C. In this manner, the apparatus may perform the user interaction in compliance with the interface style mimicry directive absent concurrent communication with the separate apparatus.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 1718 of FIG. 17 may be performed after interaction 1724. Furthermore, if desired, one or more of the above-described functions may be optional or may be combined. For example, blocks 1606 and 1608 of FIG. 16 may be optional and/or combined with block 1204 of FIG. 12.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

1-20. (canceled)

21. A method comprising:
causing establishment of a communication channel between an apparatus and a separate apparatus;
identifying the separate apparatus as a companion apparatus;
causing sending of an interface style mimicry directive to the separate apparatus based, at least in part, on the identification of the companion apparatus, the interface style mimicry directive comprising a directive that instructs the separate apparatus to perform user interaction in compliance with the interface style mimicry directive absent control from the apparatus; and
causing termination of the communication channel.

22. The method of claim 21, further comprising determination of at least one interface style setting based, at least in part, on a native interface style of the operating environment of the apparatus, wherein the interface style mimicry directive comprises information indicative of the interface style setting.

23. The method of claim 21, further comprising receiving information indicative of an operating environment of the separate apparatus, wherein the determination of the interface style mimicry directive comprises determining information associated with modification of a native interface style of the operating environment of the separate apparatus to be similar to the native interface style of the operating environment of the apparatus.

24. The method of claim 21, wherein the interface style mimicry directive is based, at least in part, on at least one interface style mimicry capability of the separate apparatus.

25. The method of claim 21, further comprising:
receiving information indicative of a change of a non-stylistic setting associated with the separate apparatus; and
causing change of a non-stylistic setting of the apparatus based, at least in part, on the information indicative of the change.

26. The method of claim 21, further comprising sending information indicative of an interface emulation program, associated with a native interface of the apparatus, to the separate apparatus.

27. The method of claim 21, wherein the interface style mimicry directive comprises information indicative of a program icon stylistic aspect of a native interface style of the apparatus, information indicative of a program icon size variability aspect of the native interface style of the apparatus, information indicative of a program icon notification presentation aspect of the native interface style of the apparatus, information indicative of an animation stylistic aspect of the native interface style of the apparatus, information indicative of radio button representation aspect of the native interface style of the apparatus, information indicative of a binary selection aspect of the native interface style of the apparatus, information indicative of a numeric selection aspect of the native interface style of the apparatus, information indicative of a navigation stylistic aspect of the native interface style of the apparatus, information indicative of a lock screen aspect of the native interface style of the apparatus, information indicative of an idle layout aspect of the native interface style of the apparatus, and information indicative of a gesture aspect of the native interface style of the apparatus.

28. An apparatus comprising at least one processor and at least one memory, the memory comprising machine-readable instructions, that when executed cause the apparatus to perform: causing establishment of a communication channel between an apparatus and a separate apparatus;
identifying the separate apparatus as a companion apparatus;
causing sending of an interface style mimicry directive to the separate apparatus based, at least in part, on the identification of the companion apparatus, the interface style mimicry directive comprising a directive that instructs the separate apparatus to perform user interaction in compliance with the interface style mimicry directive absent control from the apparatus; and
causing termination of the communication channel.

29. At least one non-transitory computer readable medium comprising instructions that, when executed, perform:
causing establishment of a communication channel between an apparatus and a separate apparatus;
identifying the separate apparatus as a companion apparatus;
causing sending of an interface style mimicry directive to the separate apparatus based, at least in part, on the identification of the companion apparatus, the interface style mimicry directive comprising a directive that instructs the separate apparatus to perform user interaction in compliance with the interface style mimicry directive absent control from the apparatus; and
causing termination of the communication channel.

30. A method comprising:
causing establishment of a communication channel between an apparatus and a separate apparatus;
identifying the separate apparatus as a primary apparatus to which the apparatus is a companion apparatus;
receiving an interface style mimicry directive from the separate apparatus based, at least in part, on the identification of the primary apparatus, the interface style mimicry directive comprising a directive that instructs the apparatus to perform user interaction in compliance with the interface style mimicry directive absent control from the separate apparatus;
causing termination of the communication channel; and
performing user interaction in compliance with the interface style mimicry directive.

31. The method of claim 30, further comprising determining at least one interface style setting based, at least in part, on a native interface style of the operating environment of the apparatus and the interface style mimicry directive, wherein the interface style setting governs a stylistic aspect that differs between the native interface style of the operating environment of the apparatus and the interface style mimicry directive.

32. The method of claim 30, further comprising causation of sending information indicative of an operating environment of the apparatus.

33. The method of claim 30, further comprising:
receiving information indicative of a change of a non-stylistic setting associated with the separate apparatus; and
causing change of a non-stylistic setting of the apparatus based, at least in part, on the information indicative of the change.

34. The method of claim 30, wherein the interface style mimicry directive comprises information indicative of a program icon stylistic aspect of a native interface style of the apparatus, information indicative of a program icon size variability aspect of the native interface style of the apparatus, information indicative of a program icon notification presentation aspect of the native interface style of the apparatus, information indicative of an animation stylistic aspect of the native interface style of the apparatus, information indicative of radio button representation aspect of the native interface style of the apparatus, information indicative of a binary selection aspect of the native interface style of the apparatus, information indicative of a numeric selection aspect of the native interface style of the apparatus, information indicative of a navigation stylistic aspect of the native interface style of the apparatus, information indicative of a lock screen aspect of the native interface style of the apparatus, information indicative of an idle layout aspect of the native interface style of the apparatus, and information indicative of a gesture aspect of the native interface style of the apparatus.

35. The method of claim 30, further comprising selection of an interface emulation program based, at least in part, on the interface style mimicry directive, wherein performance of user interaction in compliance with the interface style mimicry directive comprises execution of the interface emulation program, the interface emulation program comprising a program that causes the apparatus to emulate, at least one stylistic aspect, indicated by the interface style mimicry directive.

36. The method of claim 35, wherein the interface style mimicry directive comprises information indicative of the interface emulation program.

37. An apparatus comprising at least one processor and at least one memory, the memory comprising machine-readable instructions, that when executed cause the apparatus to perform:
causing establishment of a communication channel between an apparatus and a separate apparatus;
identifying the separate apparatus as a primary apparatus to which the apparatus is a companion apparatus;
receiving an interface style mimicry directive from the separate apparatus based, at least in part, on the identification of the primary apparatus, the interface style mimicry directive comprising a directive that instructs the apparatus to perform user interaction in compliance with the interface style mimicry directive absent control from the separate apparatus;
causing termination of the communication channel; and
performing user interaction in compliance with the interface style mimicry directive.

38. At least one non-transitory computer readable medium comprising instructions that, when executed, perform:
causing establishment of a communication channel between an apparatus and a separate apparatus;
identifying the separate apparatus as a primary apparatus to which the apparatus is a companion apparatus;
receiving an interface style mimicry directive from the separate apparatus based, at least in part, on the identification of the primary apparatus, the interface style mimicry directive comprising a directive that instructs the apparatus to perform user interaction in compliance with the interface style mimicry directive absent control from the separate apparatus;
causing termination of the communication channel; and
performing user interaction in compliance with the interface style mimicry directive.
